(19) United States
(12) Patent Application Publication
(10) Pub. No.: US 2021/0139784 A1
(43) Pub. Date: May 13, 2021

(54) FR Compositions with Additives for Drip

(71) Applicant: Robert Valentine Kasowski, Westchester, PA (US)

(72) Inventor: Robert Valentine Kasowski, Westchester, PA (US)

(21) Appl. No.: 17/052,209

(22) PCT Filed: May 25, 2019
(86) PCT No.: PCT/US2019/034077

§ 371 Date: Nov. 2, 2020

Related U.S. Application Data
(60) Provisional application No. 62/677,145, filed on May 28, 2018.
(60) Provisional application No. 62/695,163, filed on Jul. 8, 2018.
(60) Provisional application No. 62/758,666, filed on Nov. 11, 2018.

(51) Int. Cl. C09K 21/12; C08K 5/52; C08L 23/02; C08L 77/00

(52) U.S. Cl. CPC C09K 21/12; C08K 5/5205; C08L 2201/02; C08L 77/00; C08L 23/02

(57) ABSTRACT

Ethyleneamine polyphosphates are doped with organo silanes and hydrophilic fumed metal oxides such as hydrophilic fumed silica. Such doped EAPPA can then be added to polymers, with subsequently formed FR polymer having improved resistance to becoming sticky in humid air. These compositions are inherently drip resistant in a flame. Substantial addition of hydrophilic fumed silica stops stickiness in air and improves FR as measured by LOI.

### PROVISIONAL APPLICATIONS

62/677,145 date May 28, 2018, 62/695,163 date Jul. 8, 2018, 62/758,666 date Nov. 11, 2018.

### FIELD OF INVENTION

This invention relates to formation of doped ethyleneamine polyphosphate, with a dopant chosen from the group consisting of organo silanes and fumed metal oxides such as hydrophilic fumed silica. This invention also relates to flame retardant polymer compositions containing combinations of ethyleneamine polyphosphate, doped ethyleneamine polyphosphate, and dopants to improve flame retardant properties, surface migration, and moisture resistance.

### BACKGROUND OF INVENTION

In U.S. Pat. Nos. 7,138,443; 8,212,073; 8,703,853; 9,828,501(epoxy); and US application No. 2006/0175587, PCT/US12/000247 (epoxy), and PCT/US15/65415 (synthesis), and all of which are incorporated herein by reference, ethyleneamine polyphosphates (EAPPA) are made by different methods.

A problem with polymer compositions containing EAPPA is that in humid environment moisture is absorbed that can result in surface migration and stickiness. In PCT/US12/000247, it is claimed that addition of epoxy containing compounds keeps EAPPA from bleeding out in humid conditions and becoming sticky. However, when such compositions are subjected to a water bath for one to five days, substantial amount of the EAPPA washes which reduces the flame retardant (FR) behavior. The prior art also discloses that polymer compositions containing EAPPA have a tendency to sag and drip in the UL94 FR test resulting in poor performance. It was disclosed that hydrophobic fumed silica added to FR polymer compositions reduces the drip and sag in the UL94 test resulting in much better performance in the test. It was not disclosed that hydrophobic fumed silica does not help moisture resistance. There is a very big problem from dusting (dust escapes the equipment) when fumed silica is added to polymer compositions as the bulk density is very low. It is also very difficult to add a high loading (2% or more by weight) of fumed silica to compositions formed by use of extruders. EAPPA subjected to condensation to remove monomer phosphate and low molecular weight can reduce the pH indicating some degradation. An alternative method to condensation of EAPPA to remove low molecular weight polyphosphate would be desirable.

Hydrophilic fumed silica and organo silane containing compounds of this invention are not suggested in the prior art as advantageous to be added to EAPPA and polymer compositions containing EAPPA to stop surface migration or flame retardant properties. Organo silanes are mentioned in U.S. Pat. No. 8,703,853 as being surface treatments for fumed silica for making them hydrophobic. Neither is there mention of using combinations of organo silanes similar to that of adhesives. There is mention of fumed silica as drip suppressant, with hydrophobic fumed silica as being preferred. There was no recognition previously how addition of 2% or more of hydrophilic fumed silica causes the LOI to increase very significantly and abate surface migration.

There is no mention of hydrophilic fumed silica enabling greater than 60% loadings of EAPPA into polymers and stopping stickiness in air from moisture and that it is preferred to have at least 2% hydrophilic fumed silica by weight. It was also previously unknown that the lubricant poly alpha olefin can be replaced by an organo silane. It is specifically stated in PCT/US15/65415 that to obtain total FR loading greater than 57% a second flame retardant such as FP2100J is necessary as well as hydrophobic fumed silica.

The invention utilizes organo silanes and hydrophilic fumed silica to improve the surface migration resistance of EAPPA, flame resistance in polymers, and drip suppression of flame retarded polymer compositions. A doped EAPPA facilitates formation of such compositions.

### SUMMARY OF INVENTION

High molecular weight EAPPA has been made for the first time directly by the reaction of ethyleneamine with polyphosphoric acid that has been subjected to condensation (condensed polyphosphoric acid) and with the ratio of condensed polyphosphoric acid (PPAC) to ethyleneamine chosen so that the pH of a 10% aqueous solution by weight of the resulting composition is at least 2.7. This is the first EAPPA composition with molecular weight suitable for addition to polymers without the need for EAPPA condensation. A doped flame retardant composition (EAPPA-D) has been formed comprising a reaction of ethyleneamine with doped polyphosphoric acid formed by reacting polyphosphoric acid or condensed polyphosphoric acid with one or more dopants chosen from the group consisting of polyalpha olefin, hydrophilic fumed metal oxides (FMO), nanocomposites, chopped aramid fibers, wool fibers, epoxy, and organo silane, and the dopants have the property of being compatible in polyphosphoric acid or condensed polyphosphoric acid, and with the ratio of doped polyphosphoric acid to ethyleneamine chosen so that the pH of a 10% aqueous solution by weight of the resulting composition is at least 2.7. This composition melts into polymers and inherently contains the drip suppressant fumed silica necessary for drip suppression in flame retarded polymer compositions and eliminates the dusting problem with addition of fumed silica.

A method for preparation of the doped flame retardant composition (EAPPA-D) comprises the formation of doped polyphosphoric acid by mixing either polyphosphoric acid or condensed polyphosphoric acid with at least 0.1% by weight relative to the doped polyphosphoric acid one or more dopants chosen from the group consisting of polyalpha olefin, fumed metal oxides (FMO), nanocomposite, epoxy, and organo silane, and with the dopants having the property of being compatible with polyphosphoric acid and then reacting the doped polyphosphoric acid with an ethyleneamine (EA) at a reaction ratio and at a temperature without solvents so that the reaction of EA and doped polyphosphoric acid goes to completion.

Another method for preparation of the doped flame retardant composition comprises the formation of ethyleneamine polyphosphate by mixing either polyphosphoric acid or condensed polyphosphoric acid with ethyleneamine at a reaction ratio and at a temperature without solvents so that the reaction of EA and polyphosphoric acid goes to completion and then adding at least 0.1% by weight relative to ethyleneamine polyphosphate one or more dopants chosen from the group consisting of polyalpha olefin, fumed metal oxides (FMO), nanocomposite, chopped aramid fibers, natural fibers, epoxy, and organo silane and a temperature maintained that the composition is in the melted state.

The method requires that the equipment contain the reaction and that the temperature be high enough so that intermediate doped EAPPA melts and mixes with remaining PPA and EA so that the reaction is completed at the desired pH. It is important that the melt be kept at a temperature that keeps intermediate EAPPA melted and allows extraction at completion. It is possible to simultaneously add the two ingredients to a reaction chamber at adequate temperature to maintain melt and extract continuously as done for ammonium phosphate fertilizers (U.S. Pat. No. 4,104,362).

If hydrophilic fumed silica (FS) is the dopant, then EAPPA-FS is formed. The EAPPA-D in FR polymer compositions has increased drip suppression and surface migration resistance.

These FR compositions can be subjected to condensation to remove low molecular weight including orthophosphate if made with PPA that has not been condensed.

A flame retardant polymer composition has been formed comprising a) a polymer and b) one or more flame retardant compositions chosen from the group consisting of EAPPA made with condensed polyphosphoric acid and EAPPA-D that has been condensed. Such compositions can contain the fumed silica for drip suppression without direct addition. The flame retardant polymer composition is formed with a thermoplastic polymer and the composition additionally contains one or more additives preferably in an amount of at least 0.1% by weight with respect to the final weight selected from the group consisting of 1) polymer grafting agent; 2) polyalpha olefin; 3) an anti drip compound chosen from the group consisting of hydrophilic fumed silica, hydrophilic organo silane treated fumed silica, chopped natural fiber, chopped aramid fiber, chopped cotton, chopped wool, wood flour, and an organo silane containing compound. Compositions with very loadings of EAPPA can be made without the need for a second particulate flame retardant.

For fibers, the flame retardant polymer composition comprises: a) a thermoplastic polymer, b) one or more flame retardant compositions selected from the group consisting of condensed ethyleneamine polyphosphate doped with organo silane and EAPPA made with condensed PPA and c) an organo silane in an amount of at least 0.1% by weight with respect to the final composition.

It was unexpected that doped EAPPA would melt into polymer. Use of EAPPA-D increases the amount of FR that can be melted into polymers without introducing stickiness and increases FR performance as measured by limiting oxygen index (LOI). The resulting polymer compositions resulting from the addition of doped EAPPA have a distinct improvement in drip suppression in a flame and resistance to becoming sticky in a humid environment (bleed out).

Organic polymers have an inherent incompatibility with inorganic/organic polymeric compounds such as EAPPA limiting how much EAPPA can be added or are dispersible in the polymer. It has been found that special lubricants especially polyalpha olefins (PAO) are necessary to obtain high loading of EAPPA into FR polymer compositions. It is also possible to form a concentrate at 67% loading of doped EAPPA. Then form FR polymer compositions utilizing both the EAPPA-D and the concentrate to get high loading of FR.

The flame retardant polymer compositions have the property of thermal barrier protection if the flame retardant polymer composition has a limited oxygen index (LOI) greater than 32.

### DETAILED DESCRIPTION OF INVENTION

The synthesis of flame-retardants using polyphosphoric acid is disclosed in U.S. Pat. Nos. 7,138,443, 8,212,073; WO 2011/049615 (PCT/US12/000247), PCT/US15/65415, PCT/US2003/017268, and U.S. Pat. No. 8,703,853. The entire disclosure is incorporated herein by reference. These references list the polymers both thermoplastic and thermoset that these flame-retardants are applicable to. Thus far, EAPPA is applicable in some form to all polymers which are listed in U.S. Pat. Nos. 7,138,443, 8,212,073, and 8,703,853. EAPPA is not usable in chlorinated polymers such as PVC.

Most of the widely used organo silanes have one organic substituent and three hydrolysable substituents. In the vast majority of surface treatment applications, the alkoxy groups of the trialkoxysilanes are hydrolyzed to form silanol-containing species. Reaction of these organo silanes involves four steps. Initially, hydrolysis of the three labile groups occurs. Condensation to oligomers follows. The oligomers then hydrogen bond with OH groups of the substrate. The substrate in this invention is primarily hydrophilic fumed silica, but an interaction of unknown strength with OH function of phosphates could be applicable because of the high temperatures used in processing. Finally during drying or curing, a covalent linkage is formed with the substrate with concomitant loss of water. Although described sequentially, these reactions can occur simultaneously after the initial hydrolysis step. At the interface, there is usually only one bond from each silicon of the organo silane to the substrate surface. The two remaining silanol groups are present either in condensed or free form. The R group remains available for covalent reaction or physical interaction with other phases. Organo silanes can modify surfaces under anhydrous conditions consistent with monolayer and vapor phase deposition requirements.

The term phosphorous acid (PA) will denote orthophosphoric acid, pyrophosphoric acid, and polyphosphoric acid (PPA). Polyphosphoric acid (PPA) contains various chain length polyphosphoric acids as well as ortho and pyro. The preferred acid for making the compositions is polyphosphoric acid grade 115% to 118% or even higher as contains primarily long chain molecules. The least preferred is PPA 105%. The preferred ortho phosphoric acid contains 4% water or less.

The production of PPA provides a distribution of chain lengths, where the number of repeat units in the PPA chain n, varies from one chain to the next. The 105% PA grade from Innophos Corp. contains for the most part short monomer pyro segments, ortho (54%), pyrophosphoric (41%) and 5% triphosphoric and pours easily and would not be expected to provide a route to high molecular weight EAPPA unless subjected to condensation. In the higher 115% grade, little monomer is left as most of the chain lengths are 2-14 units long. This increase in chain length leads to chain entanglements and explains the increased viscosity of the higher grades. Only the 117% grade (3% Ortho, 9% pyro, 10% tri, 11% tetra, 67% higher acids), 115% grade (5% ortho, 16% pyro, 17% tri, 16% tetra, 46% higher) and 105% grade are used throughout the examples. They are from Innophos, Trenton, N.J.

Polyphosphoric acid has a large amount of undesirable ortho and pyro. Such small molecular weight content can be removed by subjecting PPA to condensation (condensed polyphosphoric acid) by heating and applying vacuum. The temperature can be well above 200° C., because PPA has a very high boiling point and there are no apparent side reactions possible. Formation of condensed polyphosphoric acid enables the use of high molecular weight PPA that would not pour at room temperature.

Doped polyphosphoric acid is formed by reacting polyphosphoric acid or condensed polyphosphoric acid with one or more dopants chosen from the group consisting of polyalpha olefin, hydrophilic fumed metal oxides (FMO), nanocomposites, chopped aramid fibers, wool fibers, epoxy, and organo silane, and the dopants have the property of being compatible in polyphosphoric acid or condensed polyphosphoric acid.

Compatible here is the property of substances like hydrophilic fumed metal oxides and organo silanes to mix into a PPA to form a doped PPA that appears to be uniform. The hydroxyl bonds solvate the PPA that is very hydroscopic. If the reaction of dopant and PPA causes dehydration, then the water molecules cause degradation of molecular weight and the flow is changed from viscous to pouring and is not compatible. A practical guide to meaning of compatible is that the reaction between dopant and PPA or EAPPA maintains similar viscosity before and after introducing the dopant and does not become much darker in color.

### Reactions of PPA with Hydrophilic Fumed Silica and Organo Silanes

A small amount of heat is released when hydrophilic fumed silica is mixed into PPA without a large reduction in viscosity indicating a reaction but still consistent with the adopted definition of compatible. The released heat is the heat of formation formed upon the ingredients reacting to form doped PPA. The preferred hydrophilic fumed metal oxide is hydrophilic fumed silica with the property that it is hydrophilic and readily disperses into PPA. Other hydrophilic fumed metal oxides are expected useful in the same may. Such fumed metal oxides could contain an organo silane treatment provided they disperse well into PPA and do not decompose the PPA to form phosphates. Hydrophobic fumed silica did not mix into PPA but floats on top.

Cotton and wood fibers when mixed with PPA at elevated temperatures turn the mixture black indicating decomposition and unsuitable and is an example of incompatible. PPA extracts water from cotton and wood causing black color. The stability of fumed silica in PPA was unexpected as fumed silica is covered in hydroxyls. Dehydration of materials like cotton and wood by PPA enables decomposition of PPA to lower molecular weight, as the water molecule enables chain reduction. When cotton or wood is added to the reactor containing melted EAPPA, the product does not turn black indicating that dehydration is not occurring on a scale that is visible. Thus, EAPPA has much reduced ability to cause dehydration which is fortunate and enables a new method to create doped EAPPA with materials such as wood and cotton. This method was unsuccessful with hydrophobic fumed silica which floated on top of the molten EAPPA in the reactor and was unmixed. In previous work (U.S. application Ser. No. 15/323,960), a grinder was used to mix hydrophobic fumed silica with DETAPPA at room temperature. A powder forms a very different behavior than for hydrophilic fumed silica.

In a small plastic container, 9 g of PPA 115% was reacted with 0.5 g Aerosil 200. PPA 115% is quite viscous. The container becomes warm from the reaction of PPA and hydrophilic fumed silica. The heat signals that PPA and hydrophilic fumed silica are reacting as the mixing is occurring. After seven days in a closed but not air tight container, the mixture became transparent and quite viscous. There has been little change after three weeks. There has been no sign of degradation of the polyphosphoric acid to phosphoric acid by absorption of water.

Twenty g PPA 115% was placed in same plastic container with lid. After 3 weeks, the PPA 115% has converted to a form with low viscosity similar to a very low grade polyphosphoric acid. Such behavior is so different than that of PPA 115 reacted with hydrophilic fumed silica. It seems that the hydrophilic fumed silica prevented the conversion to a very low grade polyphosphoric acid. Polyphosphoric acid is a desiccant that extracts water from air. Hydrophilic fumed silica reacts with PPA 115% to greatly reduce the desiccant behavior.

Reaction barrier can be thought of as the height of the potential barrier (sometimes called the energy barrier) separating two minima of potential energy (of the reactants and product of a reaction). The product formed will be EAPPA doped with a second ingredient that is compatible in polyphosphoric acid (PPA). A chemical reaction proceeds at a reasonable rate when an appreciable number of molecules have energy equal to or greater than the reaction barrier. Good mixing requires all ingredients (EA, doped PPA, and doped EAPPA) in the reaction including the doped EAPPA product to flow well, which requires the apparatus be at a temperature that intermediate doped EAPPA and final doped EAPPA be melted. As doped EAPPA is a polymer, the reaction energy or reaction barrier is the temperature at which the reactants EA and doped PPA including doped EAPPA mix well to completion.

The temperature at which a complete reaction occurs is lowest for PPA 105%. If the temperature of the reaction vessel is 200° C. then the reactions have been found to complete for all the molecular weight grades of PPA. The EA and doped PPA can be added simultaneously and mixed so that the product is continuously formed.

The difficulty in getting complete reaction of EA and doped PPA of any grade is overcome by adding the ingredients in a heated closed mixer that mixes the doped EAPPA as formed so that the EA, doped PPA, and doped EAPPA can go to complete reaction and obtain the desired pH. It has been necessary for heating to be added to the reaction vessel as the doped EAPPA has to melt to enable full reaction practical and to extract the product. The reaction is so quick that unwanted side reactions were not observed such as cross linking or interaction of EA molecules, even in a closed container.

Nanocomposites are multiphase solids of 1, 2, or 3 dimensions with at least one dimension being less than 100 nm in size. Exfoliated Organo clays are considered prime examples as consisting one dimension sheets of clay, with only one dimension less than 100 nm thick. Clay compounds contain various constituents such as Mg, AL, and Si. Mg and Al have strong interaction with polyphosphoric acid whereas Si does not. Nano composite clays routinely used to reinforce mechanical properties of polymers. Thus, fumed silica is considered separately as its behavior is very different than nano clays.

Fumed silica, also known as pyrogenic silica because it is produced in a flame, consists of microscopic droplets of amorphous silica fused into branched, chainlike, three-dimensional secondary particles which then agglomerate into tertiary particles. The resulting powder has an extremely low bulk density and high surface area. Its three-dimensional structure results in viscosity-increasing, thixotropic behavior when used as a thickener or reinforcing filler. Fumed silica has a very strong thickening effect. Primary particle size is 5-50 nm. The particles are non-porous and have a surface area of 50-600 m2/g. Density 160-190 kg/m3. Fumed silica is so fluffy that it is difficult to add to extruders for making polymer compositions and difficult to mix a fluffy material with polymers of much higher bulk density. By adding hydrophilic fumed silica to our flame retardant, this problem is overcome by adding hydrophilic fumed silica directly to PPA or EAPPA in a reactor and mixing to form a uniform composition.

Fumed silica (CAS number 112945-52-5), also known as pyrogenic silica because it is produced in a flame, consists of microscopic droplets of amorphous silica fused into branched, chainlike, three-dimensional secondary particles which then agglomerate into tertiary particles. The hydrophilic nature of fumed silica is a result of the attachment of hydroxyl groups onto silica atoms just at the surface of the particle; the product is now capable of hydrogen bonding—this makes it dispersible in water. By reacting hydrophilic fumed silica with reactive organo silanes, hydrophobic silica is often produced but hydrophilic is also possible.

Hydrophilic fumed metal oxides can be made from other elements such as titanium oxide, aluminum oxide, and iron oxide. Other metal oxides could become available. Such compounds are expected to be useful as drip suppressants in flame retarded polymer compositions. Hydrophilic fumed metal oxides suppress migration of our EAPPA-D and EAPPA to the surface. Hydrophobic fumed metal do not suppress migration to the surface.

The terms hydrophilic fumed silica and fumed silica may be used interchangeably as hydrophobic fumed silica will be shown to be less preferred.

A dopant is an impurity added to a pure substance to alter its properties. The preferred form of EAPPA used here is doped diethylenetriamine polyphosphate (DETAPPA-D) made from ethyleneamine and polyphosphoric acid doped with a hydrophilic compound compatible in PPA. For DETA, the doped DETAPPA with hydrophilic fumed silica is also referred to as PNS-FS, DETAPPA-FS, R200 and R200-9-9. DETAPPA is the same as PNS. Molecular weight of flame retardant compositions can be increased by heating at high temperatures under vacuum which will be referred to as condensation. All FR polymer compositions are made with a flame retardant composition that has been subjected to condensation. FR polymer compositions made with condensed PPA do not need to be subjected to condensation, significant cost reduction in production and improvement in quality as no degradation.

Unless the context indicates otherwise, in the specifications and claims, the terms such as ethyleneamine polyphosphate, anhydrous ethyleneamine polyphosphate, flame retardant composition, flame retardant polymer composition, and similar terms includes mixtures of such materials. Unless otherwise specified, all percentages are percentages by weight relative to total weight of composition and all temperatures are in degrees Centigrade (° C.) unless specified in ° F. All thermo graphic analysis (TGA) is performed in nitrogen at 20° C. per minute. Ingredients such as release agents, color, re-enforcement agents, heat stabilizers, acid scavengers, etc. are routinely added and should be routinely applied. Flame resistance, flame retardant, and flame retardance are used interchangeably. LOI is the % oxygen at which a polymer sample will burn when burned from above with a particular torch. The test requires a LOI testing machine as well as particularly shaped sample as described in ASTM D2863. The measurement of the minimum oxygen concentration to support candle-like combustion of plastics (Limited Oxygen Index-LOI) is done by ASTM D2863.

Ethyleneamines are defined here as ethylene diamine and polymeric forms of ethylene diamine including piperazine and its analogues. A thorough review of ethyleneamines can be found in the Encyclopedia of Chemical Technology, Vol 8, pgs. 74-108. Ethyleneamines encompass a wide range of multifunctional, multi reactive compounds. The molecular structure can be linear, branched, cyclic, or combinations of these. Examples of commercial ethyleneamines are ethylenediamine (EDA), diethylenetriamine (DETA), piperazine (PIP), triethylenetetramine (TETA), tetraethylenepentamine (TEPA), and pentaethylenehexamine (PEHA). Other ethyleneamine compounds which are part of the general term ethyleneamine (EA) which may be applicable are, aminoethylenepiperazine (EAP), 1, 2-propylenediamine, 1, 3-diaminopropane, iminobispropylamine, N-(2-aminoethyl)-1,3-propylenediamine, N, N′-bis-(3-aminopropyl)-ethylenediamine, dimethyl aminopropylamine, and triethylenediamine. Ethyleneamine polyphosphate can be formed with any of these ethyleneamines.

Organo silanes are known to dramatically improve the adhesion of polymeric resins to substrates such as glass, silica, alumina or active metals. Typically, the organo silane is functional at both ends and R is an active chemical group such as vinyl, amino (NH2), mercapto (SH) or isocyanato (NCO). This functionality can react with functional groups in an industrial resin or bio molecule such as peptides, oligonucleotides or DNA fragments. The other end consists of an alkoxy (most often methoxy or ethoxy) silane. This functionality is converted to active groups on hydrolysis called silanols. The silanols can further react with themselves, generating oligomeric variations. All silanol variations can react with active surfaces that themselves contain hydroxyl (OH) groups. The terms silane, organo silane, and organo silane coupling agent are used interchangeably.

Various manufacturers offer organo silanes with various R active chemical groups or functions. Some are offered as oligomers. For example, some of the available organo silanes are vinylsilane, aminosilane (NH2), mercaptosilane (SH), isocyanatosilane (NCO), methacrylyl silane, styryl functional silanes, alkanolamine functional silanes, epoxycyclohexyl, glycidoxy functional silanes, aminoalkylsilanes, mercaptoalkylsilanes, alkylsubstituted silane, vinyl or methacryloxy groups silane, alkyl- and arylsilanes, propyl-, isobutyl- or octyltrialkoxysilanes, functional dipodal silanes and combinations of nonfunctional dipodal silanes, and cyclic azasilanes. There will be different organic content from different sources. For example, amino silane requires at least one amino group as well as an alkoxy silane to be an aminosilane. The amninosilane could be oligomeric as well.

The two main classes of organo silanes employed are methoxy and ethoxy silanes. Methoxy silanes are of intermediate reactivity and evolve toxic methanol. Amino silanes form species that are among the most stable water borne species. They readily dissolve in water on stirring and are most stable at pH 10-11. The group R may interact with the polymer through a purely physical entanglement (IPN=interpenetrating network), hydrogen bonding, Van Der Wals interactions or covalent chemical bonding. Of these covalent bonding is preferred for long term stability at the polymer/silane interface. Once an organo silane is covalently bound to the substrate, a wide range of chemical reactions are available for binding to the polymer. Such reactions are available for vinyl, amino, epoxy and mercapto functionalized surfaces with functionalities readily achievable on a polymer or biopolymer. For example, isocyanate functionality can react with hydroxyls, amines or mercaptans. Amino groups can react with acids, amides, phosphate esters etc.

Most organo silanes have moderate thermal stability making them suitable for plastics that process below 350° C. or have continuous temperature exposures below 150° C. Organo silanes with an aromatic nucleus have higher thermal stability. Thus, FR engineering polymers require higher thermal stability organo silanes than olefin polymers.

In general, due to the wide variety of processing conditions and formulation variables, it cannot be predicted which class of a recommended group of organo silanes will prove most effective.

Water for hydrolysis may come from several sources. It may be added, it may be present on the substrate surface, or it may come from the atmosphere. The degree of polymerization of the organo silanes is determined by the amount of water available and the organic substituent. EAPPA can also be a source of water by condensation.

Organo silanes find their largest application in the area of polymers. Since any organo silane that enhances the adhesion of a polymer is often termed a coupling agent, regardless of whether or not a covalent bond is formed, the definition becomes vague. The covalent bond may be formed by reaction with the finished polymer or copolymerized with the monomer. Thermoplastic bonding is achieved through both routes, although principally the former. Thermosets are almost entirely limited to the latter. The mechanism and performance of organo silanes is best discussed with reference to specific systems.

Thermoplastics provide a greater challenge in promoting adhesion through organo silanes than thermosets. The organo silanes must react with the polymer and not the monomeric precursors, which not only limits avenues for coupling, but also presents additional problems in rheology and thermal properties during composite formulation. Moreover mechanical requirements here are stringently determined. Polymers that contain regular sites for covalent reactivity either in the backbone or in a pendant group include polydienes, polyvinylchloride, polyphenylene sulfide, acrylic homopolymers, maleic anhydride, acrylic, vinyl acetate, diene-containing copolymers, and halogen or chlorosulfonyl-modified homopolymer. A surprising number of these are coupled by aminoalkylsilanes. The most widely used organo silanes, the aminoalkylsilanes, are not necessarily the best. Epoxysilanes, for example, are successfully used with acrylic acid and maleic acid copolymers. Epoxysilanes should react well with EAPPA.

The group of polymers that most closely approaches theoretical limits of composite strength does not appear to contain regular opportunities for covalent bond formation to substrate. Most of the condensation polymers including polyamides, polyesters, polycarbonates, and polysulfones are in this group. Adhesion is promoted by introducing high energy groups and hydrogen bond potential in the interphase area or by taking advantage of the relatively low molecular weight of these polymers, which results in a significant opportunity for end-group reactions. Aminoalkylsilanes and isocyanatosilanes are the usual candidates for coupling these resins and are part of this invention. This group has the greatest mechanical strength of the thermoplastics, allowing them to replace the cast metals in such typical uses as gears, connectors and bobbins.

The polyolefins and polyethers present no direct opportunity to covalent coupling, except for end groups.

Organo silanes are generally recommended for applications in which an inorganic surface such as hydrophilic fumed silica has hydroxyl groups and the hydroxyl groups can be converted to stable oxane bonds by reaction with the organo silane.

Organo silane terminated polymers are also part of this invention and part of organo silanes. Most of the conventional organo silane-terminated polymers (SMP) currently available on the market are based on a high molecular weight polypropylene glycol (PPG) backbone. Because of the availability of high-molecular-weight PPGs, the range of possible structures, chain lengths, and polarities is severely limited. The PPG backbone is terminated with silane groups, either directly (in silane terminated polyether SPEs) or via a urethane group (in silane terminated polyurethane SPUR). The organo silane is terminated by CH3 and OMe groups. The SPE and SPUR polymers are cured under humid conditions and at room temperature, usually by using an appropriate catalyst such as dibutyl dilaurate. Generally, methanol or ethanol is released during crosslinking. In currently available silane-terminated polymers, the polypropylene glycol (PPG) backbone is terminated with silane groups either directly (in SPEs) or via a urethane group (in SPUR).

In a new type of SMP, the organo silane functional groups are not incorporated in a terminal position, but are distributed over the polymer chain as side groups in a targeted manner

Wood-plastic composites (WPCs) are composite materials made of wood fiber/wood flour and thermoplastic(s) (includes PE, PP, PVC, PLA etc.). In addition to wood fiber and plastic, WPCs can also contain other ligno-cellulosic and/or inorganic filler materials. WPCs are a subset of a larger category of materials called natural fiber plastic composites (NFPCs).

It has been discovered that wood flour is an effective drip suppressant. Wood flour is an example of a class of materials known as natural fibers which contain cellulose. A few examples of natural fibers are cotton, wool, bamboo, sugar cane bagasse, bast (such as juke, flax, ramie, hemp, kenaf), seed (such as cotton, coir, kapok), leaf (such as sisal, pineapple, abaca), grass and reed (such as rice, corn, wheat) as well as wood and roots. Natural fiber composites (NFPC) are a composite material consisting of a polymer embedded with natural fibers. Wood polymer composites (WPC) are a composite material consisting of a polymer embedded with wood fibers. It is found that NFPC's and WPC's can be efficiently flame retarded with EAPPA-D. Natural fibers such as wood flour provide drip suppressant behavior as a substitute for fumed silica. Such behavior is expected for other natural fibers such as cotton. Aramid fibers are part of this invention. Wood fibers, wood flour and cotton react with PPA and are not suitable as dopants added directly to PPA with subsequent addition of EA. However, additives such as these can be added to EAPPA in the melted state after synthesis. Such additives are suitable to be added when a flame retarded polymer composition is being formed with EAPPA, EAPP-D or combination of EAPPA and EAPPA-D.

Aramid fibers are part of this invention. Aramid Fibers, trade names Kevlar®, Twaron®, Nomex®, Technora® Aramid fibers are another group of super-heros of the fiber world. Kevlar and other polyamides, all conjure up images of ultra strong materials that are elbowing out more conventional construction materials such as steel. Aramid, in full aromatic polyamide, any of a series of synthetic polymers (substances made of long chainlike multiple-unit molecules) in which repeating units containing large phenyl rings are linked together by amide groups. Amide groups (CO—NH) form strong bonds that are resistant to solvents and heat.

The wood additives, natural fibers and aramid fibers do not melt. In a flame these fibers convert to char and are thus a critical property of suitable dopants added before synthesis or after synthesis of EAPPA. The char in the form of fibers shows drip suppressance behavior for EAPPA polymers containing char forming fibers.

EAPPA can be solvated by OH bonds of hydrophilic fumed metal oxides such as hydrophilic fumed silica (FS). In the solvated state, an ion in a solution is surrounded or complexed by solvent molecules. The EAPPA polymer could wrap around hydrophilic partially at the high temperatures of extrusion, whereas such a reaction would not be expected for hydrophobic fumed silica. The solvating interaction could differ for high temperature extrusion of engineering polymers as compared to low temperature extrusion of olefins. Epoxy bonds are expected to directly bond to EAPPA mostly by the amine content. Organo silanes and hydrophilic fumed silica can bond directly to EAPPA or they can solvate the EAPPA to reduce attraction for water. The solvated state is lower energy than hydrophilic fumed silica and EAPPA separately. Natural fibers such as wood should also have solvating effect due to large amount of hydroxyl bonds

When hydrophilic fumed silica is mixed with PPA, the PPA/fumed silica gets quite warm indicating a reaction. In fact, a new form of EAPPA containing hydrophilic fumed silica (EAPPA-doped with hydrophilic fumed silica) will be produced that mixes with polymers via extrusion more easily. Organo silanes mixed with PPA heat give off indicating a reaction. Fibers mixed with PPA give off heat indicating a reaction.

A variety of epoxy containing compounds mixed with PPA give off heat indicating a reaction. This doped PPA will then be reacted with ethyleneamine to form EAPPA-D; These EAPPA-D compositions when added to polymers create FR polymer compositions that have reduced bleed out in humid conditions.

This specific reaction of hydrophilic fumed silica with PPA was not appreciated or divulged in previous work nor the reaction of PPA with other hydroxyl containing compounds or with epoxy containing compounds or with aramid fibers.

The hydroscopic nature of EAPPA drives moisture absorption in FR compositions. The introduction of organo silanes and hydrophilic fumed silica provides hydroxyls to attach to PPA to reduce hydroscopic force and stop bleed out in polymer compositions. Crosslinking of FR composition with organo silanes further decreases ability to incorporate moisture from outside. The samples still absorb water but do not have a problem with migration to the surface resulting in stickiness in humid environment. In highly filled EAPPA polymer compositions, hydrophilic fumed silica enables higher loadings that do not get sticky in air. There is a surface reaction between hydrophilic fumed silica and EAPPA to drive better dispersion and also result in better drip suppression in a flame. There is no such reaction with hydrophobic fumed silica in highly filled EAPPA polymer compositions. Thus, FR polymer compositions that do not get sticky in air can be made without including an epoxy containing polymer such as polymer grafting agent.

For FR polymer compositions with about 60% EAPPA, the best FR performance is obtained with a loading of hydrophilic fumed silica of 2.0% or more by weight of final composition. A lubricant such as poly alpha olefin (PAO) mixed with the hydrophilic fumed silica is needed to enable the ingredients to fully mix into an EVA polymer composition in a batch mixer. An alternative approach is to mix hydrophilic fumed silica with an organo silane such as vinyl silane to enable the ingredients to fully mix into an EVA polymer composition in a batch mixer. Thus, a new composition of matter would be desirable that inherently contains a drip suppressant. It has been found that the more drip suppressant incorporated into polymer compositions, the better the FR properties.

The preferred acid is polyphosphoric acid. It was surprising that the product of polyphosphoric acid/hydrophilic fumed silica and ethyleneamine reacted and formed a melt that could be removed from the heated reaction kettle, making production practical. More generally, ethyleneamine polyphosphate-hydrophilic fumed metal oxide (EAPPA-FMO) can be formed and claimed. The new composition (EAPPA-FS, with hydrophilic fumed silica) is very brittle but still melts into polymers. Such new FR compositions enable large amounts of hydrophilic fumed metal oxides to be dispersed into polymers with standard production equipment. Hydrophilic fumed silica is very powdery and difficult to feed uniformly to an extruder, as the other ingredients have much higher bulk density. Materials of very different bulk density are problematic at the extruder feed entrance for ingredients because of separation at the fast rotating screw. EAPPA doped with hydrophilic fumed silica overcomes issues with feeding hydrophilic fumed silica into extruders and also results in better distribution of hydrophilic fumed silica in polymers flame retarded with EAPPA doped with hydrophilic fumed silica. It is preferred that EAPPA-FS contain at least 2% by weight hydrophilic fumed silica (FS).

The polymers used are Elvax 260 and PTW from the DuPont Company, Wilmington, Del. From Momentive Performance Material, Waterford, N.Y., the products used are SPUR 1015LM, Silquest 187, and CoatOSil MP 200. CoatOSil MP 200 silane is an epoxy functional silane oligomer. Silquest 187 is an epoxy silane. From Evonik Corp., Parsippany, N.J. 07054, Dynasylan 1146 (amino oligomer), Dynasylan 6490 (vinyl oligomer), and TEGOPAC 150. FP2100J from Adeka Corporation, Tokyo, Japan. FP2100 and FP2100J are the same. Synfluid mPAO 150 Cst (PAO) obtained from Chevron Phillips, Woodlands, Tex. It is sometimes useful to add a particulate flame retardant such FP2100J by Adeka Corp. or Melapur 200 sold by BASF Corporation. As catalyst from Lyondell corporation, Aquathene CM04483 is designed for moisture curing ethylene vinyl silane polymer (EVS). The catalyst used in some examples is Accel-T by Smooth-On, Allentown, Pa. and bought from Reynolds Advanced Materials, Allentown, Pa. Chopped fibers such as cotton can be obtained from Finite Fiber, Akron, Ohio.

Vinylsilane refers to an organo silicon compound containing chemical formula CH2═CHSiH3. It is a derivative of silane (SiH4). More commonly used than the parent vinylsilane are vinyl-substituted silanes with other substituents on silicon. Vinyl silane refers here to vinyl-substituted silanes. Similarly, amino-substituted silanes are referred to as amino silane. Epoxy-substituted silanes are referred to as epoxy silane and so on for other functions. These compounds can be oligomeric as well making the compositions even more complex. The exact compositions are rarely disclosed and the manufacturer may not know the exact composition. It is expected for example that all vinyl silanes will be effective for polymers were vinyl function is appropriate. Different polymers require different organo silanes.

Dynasylan 1146, an oligomer amino silane, shows both adhesion promotion and water repellency. Dynasylan® 1146 silane is characterized by randomly distributed linear and cyclic oligosiloxanes and it fulfills the OECD polymer definition. In air it quickly converts to a hard repellant surface when applied on top of DETAPPA. Hydrophobic Dynasylan® 1146 diaminofunctional silane. Dynasylan 6490 is vinyl silane oligomer from Evonik Corp. Dynasylan® 6490 is a vinyl silane concentrate (oligomeric siloxane) containing vinyl and methoxy groups. Dynasylan® 6490 is a colorless, nearly odorless low viscosity liquid. The exact chemical compositions are not given. What is important is that the correct functional groups are contained such as vinyl, amino, or epoxy.

SPUR+ 1015LM prepolymer are a silylated polyurethane resin for manufacturing one-part, moisture-curing sealants and adhesives. Plasticizer-free and of relatively low viscosity, it is an excellent base resin for low modulus sealants in building and construction applications where good elastic recovery is required. Good adhesion to ABS, PVC, PC, and PS is reported by manufacturer. Basic composition of adhesives is SPUR silane, amino silane, and vinyl silane being approximately 50% b y weight. Inorganic filler compounds make up most of remaining weight.

To achieve moisture resistance, this invention incorporates the critical parts of a sealant or adhesive: prepolymer SPUR, SPE, NEW-SP; moisture scavenger such as vinyl silane; and adhesion promoter such as aminosilane. Other cross linkable silane containing polymers such as ethylene vinyl silane (EVS) copolymer Aquathene 120000 from Lyondell are also part of this invention. An alternative to achieve surface migration resistance is to add hydrophilic fumed silica and organo silanes to a composition containing EAPPA. For the first time, high loading of 60% EAPPA achieved in polymers without the need of a second flame retardant such as FP2100J.

Polymer compositions containing 50% or more by weight EAPPA-D can be used as a concentrate to alter the FR properties of polymers that do not accept fillers readily. For example, when EAPPA is added to EVA with fractional melt flow, the product becomes sticky in air. However, the flame retarded Elvax 260 containing 60% DETAPPA-FS is added to fractional melt flow EVA, a FR polymer is formed that does not get sticky in air.

Epoxy compounds are found to improve surface migration resistance. The teachings of PCT/US12/000247 are incorporated as well to improve surface migration resistance. The definition of epoxy and applicable epoxy compounds are found in PCT/US12/000247. The epoxy containing compounds were selected from the group consisting of polymer grafting agent; glycidyl epoxies further classified as glycidyl-ether, glycidyl-ester and glycidyl-amine; and glycidyl ethers of phenolic hydroxyl containing novolac resins. Organo silane containing the epoxy function is further added.

EAPPA melts into polymer grafting agent such as Elvaloy PTW made by Dupont Co. and epoxies such as Epon SU8, Epon 828, EPON 1007F, and EPON 1009F made by Momentive.

The grafting agents containing the epoxy group are particularly well described in U.S. Pat. No. 6,805,956 and US application 20050131120 and those descriptions are used extensively in next six paragraphs. Polymeric grafting agents, such as EBAGMA and EMAGMA, useful in the compositions of the invention are ethylene copolymers copolymerized with one or more reactive groups selected from unsaturated epoxides of 4 to 11 carbon atoms, such as glycidyl acrylate, glycidyl methacrylate (GMA), ally! glycidyl ether, vinyl glycidyl ether, and glycidyl itaconate, unsaturated isocyanates of 2 to 11 carbon atoms, such as vinyl isocyanate and isocyanato-ethyl methylacrylate, as well as unsaturated aziridines, silanes, or oxazolines and may additionally contain a second moiety such as alkyl acrylate, alkyl methacrylate, carbon monoxide, sulfur dioxide and/or vinyl ether, where the alkyl radical is from 1 to 12 carbon atoms.

In particular, the polymeric grafting agent is a copolymer of at least 50% by weight ethylene, 0.5 to 15% by weight of at least one reactive moiety selected from the group consisting of (i) an unsaturated epoxide of 4 to 11 carbon atoms, (ii) an unsaturated isocyanate of 2 to 11 carbon atoms, (iii) an unsaturated alkoxy or alkyl silane wherein the alkyl group is from 1 to 12 carbon atoms, and (iv) an unsaturated oxazoline, and 0 to 49% by weight of a second moiety selected from at least one of an alkyl acrylate, alkyl methacrylate, vinyl ether, carbon monoxide, and sulfur dioxide, where the alkyl and ether groups above are 1 to 12 carbon atoms.

Polymeric grafting agents for use in the compositions include ethylene/glycidyl acrylate, ethylene/n-butyl acrylate/glycidyl acrylate, ethylene/methylacrylate/glycidyl acrylate, ethylene/glycidyl methacrylate (E/GMA), ethylene/n-butyl acrylate/glycidyl methacrylate (E/nBA/GMA) and ethylene/methyl acrylate/glycidyl methacrylate copolymers. The preferred grafting agents for use in the compositions are copolymers derived from ethylene/n-butyl acrylate/glycidyl methacrylate and ethylene/glycidyl methacrylate.

A preferred polymeric grafting agent is a copolymer of at least 55% by weight ethylene, 1 to 10% by weight of an unsaturated epoxide of 4 to 11 carbon atoms, and 0 to 35% by weight of at least one alkyl acrylate, alkyl methacrylate, or mixtures thereof where the alkyl groups contain 1 to 8 carbon atoms. Preferred unsaturated epoxides are glycidyl methacrylate and glycidyl acrylate, which are present in the copolymer at a level of 1 to 7% by weight. Preferably, ethylene content is greater than 60% by weight and the third moiety is selected from methyl acrylate, iso-butyl acrylate, and n-butyl acrylate.

The composition of grafting polymer used is a terpolymer of 71.75 wt. % ethylene, 23 wt. % n-butyl acrylate, and 5.25 wt. % glycidyl methacrylate abbreviated as E/nBA/GMA-5. Another composition still described as EBAGMA-5 is an ethylene/n-butyl acrylate/glycidyl methacrylate terpolymer derived from 66.75 weight percent ethylene, 28 weight percent n-butyl acrylate, and 5.25 weight percent glycidyl methacrylate. It has a melt index of 12 g/10 minutes as measured by ASTM method D1238. The ethylene/acid copolymers and their methods of preparation are well known in the art and are disclosed in, for example, U.S. Pat. Nos. 3,264,272; 3,404,134; 3,355,319 and 4,321,337.

The copolymers are termed ionomers when the acid is neutralized in whole or in part to produce a salt. The cations for the salts are usually an alkali metal such as sodium, potassium, zinc or the like. “Acid copolymers” or “ionomers” referred to herein may be direct copolymers or graft copolymers. The ionomer used is a commercial product sold by DuPont as Surlyn® 9320. EBAGMA polymers are sold by the Dupont Company as Elvaloy PTW (EBAGMA-5) and Elvaloy 4170 (EBAGMA-9). The terms EBAGMA, EBAGMA-5, Lotader AX8900 and Elvaloy PTW are interchangeable. Lotader AX8900 made by Arkema is also a suitable grafting agent. It is a terpolymer of ethylene, methyl acrylate, and glycidyl methacrylate (EMAGMA). The groups of the ionomer could react with the grafting polymer but does not seem necessary from examples presented here.

There are two main categories of epoxy resins, namely the glycidyl epoxy, and non-glycidyl epoxy resins. The glycidyl epoxies are further classified as glycidyl-ether, glycidyl-ester and glycidyl-amine. The non-glycidyl epoxies are either aliphatic or cycloaliphatic epoxy resins. Glycidyl epoxies are prepared via a condensation reaction of appropriate dihydroxy compound, dibasic acid or a diamine and epichlorohydrin. While, non-glycidyl epoxies are formed by peroxidation of olefinic double bond.

Glycidyl-ether epoxies such as, diglycidyl ether of bisphenol-A (DGEBA) and novolac epoxy resins are most commonly used epoxies. Novolac epoxy resins are interchangeably described as glycidyl ethers of phenolic hydroxyl containing novolac resins or glycidyl ethers of phenolic novolac resins, with the first term being more common.

The goal is to create thermoplastic compositions at high loadings of flame-retardants to achieve very high flame retardant (FR) performance. Most of the examples will contain approximately 60% to 67% FR loading. In previous references, the polymers have not accepted a 67% loading of the EAPPA polyphosphate FR that melts into the polymer, so a particulate FR had to be added (U.S. Pat. No. 9,828,501). The particulate was FP2100J (ADK STAB FP2100J from Adeka corporation). The technology presented here is able to obtain 60% or more loading our EAPPA based flame retardants without a particulate FR.

Organic polymers have very different properties than EAPPA and thus the two are difficult to mix together especially if trying to add more than 50% by weight EAPPA to a thermoplastic polymer such as EVA. The incompatibility between EVA and EAPPA is partially overcome by using an EVA with high vinyl acetate (VA) content. Elvax 260 with VA content 28% was used in all EVA examples.

For EVA compositions with EAPPA concentration greater than 57% and hydrophilic fumed silica content greater than 2.0% by weight, it was necessary to add nearly the same weight PAO as hydrophilic fumed silica to obtain good dispersion of the polymer composition ingredients. Better dispersion for EVA/EAPPA compositions was also obtained by adding vinyl silane at about ¼ th of the weight of hydrophilic fumed silica. It is necessary to add such a large concentration of hydrophilic fumed silica to obtain the necessary drip suppressant behavior to obtain very high LOI values. Surprisingly, amino silane in EVA/EAPPA samples can lead to brittleness. Amino silane worked well with nylon/EAPPA samples. Thus, claims are difficult to write that apply generally to all polymers. It was found that use of EAPPA-hydrophilic fumed silica does not require the use of an organo silane to get 2% concentration.

The preferred epoxies will be chosen from the group consisting of Elvaloy PTW from Dupont Company, Epon SU8, Epon 828, Epon 1009F and Epon 1007F. The preferred epoxy compounds are Elvaloy PTW, Epon SU8, Epon 828, EPON 1007F, and EPON 1009F. Most preferred are Elvaloy PTW and Lotader AX8900.

The preferred polymer is EVA Elvax 260 with VA content 28% from DuPont Co. The use of particulate FR may still be included, but not preferred. Other phosphorous or nitrogen containing particulate flame retardants could be part of the final composition. For example, melamine, melamine polyphosphate, Melapur 200 from BASF, Zuran 9 from China, Prenifor from China, APP (ammonium polyphosphate made by several companies), metal phosphinates from Clariant Corporation, melamine cyanurate, ethyleneamine phosphates, and ethyleneamine pyrophosphates.

The main property of FR polymer compositions targeted for improvement was surface migration resistance, FR as measured by LOI, and elimination of the need for particulate FR to achieve loading of 57% or greater. A high loading of FR (greater than 60%) was chosen to enable quick testing for stickiness in humid environments and LOI. Most of the initial examples were made EVA as the polymer and mixed with a Brabender. The first examples (set A) focus on the improvements of surface migration resistance of FR polymer compositions by addition of organo silanes with EAPPA. These examples contain FP2100 from Adeka in order to get a high loading of FR. The examples contain hydrophobic fumed silica which is no longer the preferred. The next set of examples (set B) focus on the improvement of FR polymer compositions by using hydrophilic fumed silica, organo silanes, and EAPPA where it is possible to get high FR loading without FP2100. The last set of FR polymer compositions (set C) utilize EAPPA doped with hydrophilic fumed silica (EAPPA-FS), wood flour, PAO, and organo silanes to obtain very high LOI and samples easy to extrude without dusting problem or mixing problem. Then, guidelines for best practice will be provided.

Such compositions were made with an extremely high LOI of at least 65. However to make such compositions on a twin screw extruder required a new form of EAPPA to be invented. This doped EAPPA requires hydrophilic fumed silica to be mixed into polyphosphoric acid and then reacted with EA to form EAPPA-FS in a heated reactor, usually 200° C. Only with EAPPA-FS and extra FS mixed with a lubricant or organo silanes can compositions with LOI greater than 65% be made on twin screw extruder without dusting issues. These compositions did not appear to need the addition of organo silanes for surface migration resistance or flame retardance for EVA and nylon. Organo silanes do seem useful to be added to PE and PP FR compositions. PAO as a lubricant can be replaced by organo silanes but with a lesser FR performance.

### Set A: Examples with Organo Silanes Showing Improvement in FR and Surface Migration Resistance

Example 1: In a Brabender, 350 g DETAPPA was melted together with 20 g CoatOSil MP 200 and 10 g Dynasylan 1146 to form sample 341. Then in a twin screw extruder, a composition was produced containing 80% nylon 66 and 20% sample 341. The strand was very tough as impossible to cut with scissors. The sample exhibited better FR than sample without the organo silane as dripping greatly suppressed and flaming drips reduced as compared to control. No indication of stickiness when subjected to high humidity in a humidity chamber. It was also important that the sample 341 melted into nylon despite having been reacted with the organo silanes. In fact more examples will be made which show that DETAPPA samples that contain organo silanes mixed in at a molecular level continue to melt into various polymers, which is unexpected and of great importance. These samples were used to create nylon fibers.

Example 2: In a Brabender a sample was mixed at 170° composed of 105g Elvax 260, 7 g Elvaloy PTW, 3 g mPAO, 48 g FP2100, and 180 g sample 341. Films ⅛ inch thick were exposed to water bath for 3 days. Then 1 inch wide strips were mounted vertically and exposed from the bottom to a 6700 BTU torch for 1 minute. A control was prepared with 166 g of DETAPPA replacing sample 341, all other ingredients being the same. The control strip burned more than the sample containing the organo silanes. The strips were exposed to water bath for 3 days. The FR of the sample containing organo silane burned very similar to the sample not exposed to water. The control exposed to water bath had poorer FR indicating some of the FR washed out.

Example 3: In a Brabender, 350 g DETAPPA was melted together with 10 g Dynasylan 1146 and 25 g SPUR 1015LM to form sample 326a. Then in a twin screw extruder, a composition was produced containing 80% nylon 66 and 20% sample 326a. The strand was very tough as impossible to cut with scissors. The sample exhibited better FR than sample without the organo silane as dripping greatly suppressed flaming drips compared to control. No indication of stickiness when subjected to high humidity in a humidity chamber.

Example 3261: In a Brabender a sample mixed at 170° composed of 105 g Elvax 260, 7 g Elvaloy PTW, 3 g mPAO, 48 g FP2100J, and 180 g sample 326a. A control was prepared with 166 g of DETAPPA replacing sample 326a, all other ingredients being the same. Films ⅛ inch thick were exposed to water bath for 3 days. Then 1 inch wide strips were mounted vertically and exposed from the bottom to a 6700 BTU torch for 1 minute. The control strip burned more than the sample containing the organo silanes. The strips were exposed to water bath for 3 days. The FR of the sample containing organo silane burned very similar to the sample not exposed to water. The control exposed to water bath had poorer FR indicating some of the FR washed out.

Example 5: In a Brabender, 350 g DETAPPA was melted together with 10 g Dynasylan 1146 and 25 g TEGOPAC 150 to form sample 318a. Then in a twin screw extruder, a composition was produced containing 80% nylon 66 and 20% sample 318a. The strand was very tough as impossible to cut with scissors. The sample exhibited better FR than sample without the organo silane as dripping greatly suppressed flaming drips compared to control. No indication of stickiness when subjected to high humidity in a humidity chamber.

Example 3181: In a Brabender a sample mixed at 170° composed of 105 g Elvax 260, 7 g Elvaloy PTW, 3 g mPAO, 48 g FP2100J, and 180 g sample 318a. A control was prepared with 166 g of DETAPPA replacing sample 318a, all other ingredients being the same. Films ⅛ inch thick were exposed to water bath for 3 days. Then 1 inch wide strips were mounted vertically and exposed from the bottom to a 6700 BTU torch for 1 minute. The control strip burned more than the sample containing the organo silanes. The strips were exposed to water bath for 3 days. The FR of the sample containing organo silane burned very similar to the sample not exposed to water. The control exposed to water bath had poorer FR indicating some of the FR washed out.

Sample A was prepared in a Brabender by mixing 105 g Elvax 260, 7 g Elvaloy PTW, 3 g PAO, 49 g FP2100J, 165 g DETAPPA, 6 g SPUR 1015LM and 2 g Dynasylan 1146. The sample was not as flexible as the above samples. It is probably necessary to use a twin screw extruder to obtain better mixing.

Sample 344B: First, 1.5 g Dynasylan 1146, 3.2 Dynasylan 6490, and 41 g TEGOPAC 150 seal were mixed together. In a Brabender, 35 g of this organo silane mixture was added to 350 g DETAPPA and melted together to form sample 344B. The sample had apparent good molecular weight as draw in melted state and stickiness to beaters was lower than usual. Four grams was placed in 15 g water. Whereas, sample 318a falls apart in water and some syrup forms at bottom of vessel and a polymer containing some DETAPPA content rises above the syrup. The syrup has a high density greater than 1.4 g/ml. Thus, the vinyl organo silane was the primary difference between of 318A and 344A.

Sample 3442: In a Brabender a sample mixed at 170° C. composed of 102 g Elvax 260, 10 g Aquathene CM04483, 4 g mPAO, 48 g FP2100J, and 180 g sample 344B. Films ⅛ inch thick were exposed to water bath for 3 days. Then 1 inch wide strips were mounted vertically and exposed from the bottom to a 6700 BTU torch for 1 minute and had exceptional FR with no need for a drip suppressant. The strips exposed to water for three days lost less than 5% in weight. A control sample looses greater than 15% in weight from a water bath.

Sample 342A: First, 1.5 g Dynasylan 1146, 1.6 Dynasylan 6490, and 41 g SPUR 1015 were mixed together. In a Brabender, 40 g of this organo silane mixture was added to 350 g DETAPPA was melted together with to form sample 342A. The sample had apparent good molecular weight as draw in melted state and stickiness to beaters was much lower than usual. Four grams was placed in 15 g water. After 24 hours, the water was placed in a graduated cylinder. The weight and volume of this water from soaking 342A indicated that the water density is about 1.03 g/ml indicating a low amount of DETAPPA. The sample increased about 50% in weight and volume but was still strong. Two pieces of sample 342A weighing 2.1 g were placed in 12.2 g water and allowed to sit for two days. The two pieces now weighed 3.1 g in wet state. The sample was allowed to dry in hot air for about 12 hours until the weight was stable. The two pieces weighed 1.91 g, the small loss attributed to leaching by water, organo silane cross linking releasing alcohol, and handling. The two pieces were not sticky and did not become sticky or rehydrate when left in air for 3 days or gain weight. When left in air for one week more, the samples reduced in weight to 1.85 g, indicating the samples did not rehydrate. When pressed with a probe, there was yield and bounce back which the product out of the Brabender did not have suggesting crosslink by water from the water bath treatment. The vinyl silane has enabled the formation of a doped DETAPPA that is mostly water insoluble, a great improvement. It would have been even more successful if 342A had been moisture cured before placing in a bath. Moisture cure can consist of placing in air for two weeks or more depending on temperature and humidity. Moisture can consist of placing in sweat room held at a temperature of 50° C. and 50% relative humidity for 6 hours. These conditions can be changed substantially depending on the system.

Sample 3421: In a Brabender a sample mixed at 170° C. composed of 102 g Elvax 260, 10 g Aquathene CM04483, 4 g mPAO, 48 g FP2100J, and 180 g sample 342A. Films ⅛ inch thick were exposed to water bath for 3 days. Then 1 inch wide strips were mounted vertically and exposed from the bottom to a 6700 BTU torch for 1 minute and had exceptional FR with no need for a drip suppressant. The strips exposed to water for three days lost less than 5% in weight. A control sample looses greater than 15% in weight.

Sample 344A: First, 1.5 g Dynasylan 1146, 5.2 Dynasylan 6490, and 40 g SPUR 1015 were mixed together. In a Brabender, 31 g of this organo silane mixture was added to 350 g DETAPPA and melted together to form sample 344A. The sample did not have good molecular weight as no draw in melted state and stickiness to beaters was very low. Four grams was placed in 15 g water. After 24 hours, the water was placed in a graduated cylinder. The weight and volume of 344A indicated that the water density is about 1 g/ml indicating a low amount of DETAPPA. The sample seems to expand to about twice its weight from absorbed water. Very different behavior is observed as compared to sample 318A. A sample of 344a left in air does not slowly liquefy as does DETAPPA.

Sample 3441: In a Brabender a sample mixed at 170° C. composed of 102 g Elvax 260, 10 g Aquathene CM04483, 4 g mPAO, 48 g FP2100J, and 180 g sample 344A. Films ⅛ inch thick were exposed to water bath for 3 days. Then 1 inch wide strips were mounted vertically and exposed from the bottom to a 6700 BTU torch for 1 minute and had exceptional FR with no need for a drip suppressant. The strips exposed to water for three days lost less than 5% in weight. A control sample looses greater than 15% in weight.

Samples utilizing a tin catalyst Accel-T from Smooth-ON, Allentown, Pa., to cure the sealant that has been added to polymers flame both thermoset and thermoplastic that contain DETAPPA.

Sample 415a is prepared by mixing together 25 g SPUR 1015, 5 g Dynasylan 1146, 5 g Dynasylan 6490, and 2 g Accel-T. Sample 416a is prepared by mixing together 25 g SPUR 1015, 5 g Dynasylan 1146, 5 g Dynasylan 6490, and 4.9 g Accel-T. Sample 417a is prepared by mixing together 25 g TEGOPAC Bond150 from Evonik Corp., 4.9 g Dynasylan 1146, 5.3 Dynasylan 6490, and 5.3 g Accel-T.

Sample 4151 is prepared by adding to a Brabender set at 175 C, 173 g DETAPPA, 48 g FP2100J, 105 g EVA Elvax 260, 7 g Elvaloy PTW, 4.5 g Synfluid mpao 150, and 17 g 415a. When this composition was run in a twin screw extruder, the results had poor mixing. The results were good when the organo silanes and DETAPPA were melted together in a separate step. Then added to a polymer in a twin screw extruder to form a flame retarded polymer. This is candidate for halogen free plenum (NFPA 262) cable. A plenum cable in its simplest form is a jacket covering four pairs of insulation coated copped wires. Plenum jacket are required to pass UL 910.

Sample 4161 is prepared by adding to a Brabender set at 175 C, 173 g DETAPPA, 48 g FP2100J, 105 g Elvax 260, 7 g Elvaloy PTW, 3.5 g Synfluid mpao 150, and 22 g 416a.

Sample 4171 is prepared by adding to a Brabender set at 175 C, 173 g DETAPPA, 48 g FP2100J, 105 g Elvax 260, 7 g Elvaloy PTW, 3.9 g Synfluid mpao 150, and 23.5 g 417a. The samples were exposed to 75% relative humidity for two weeks so that the sealant within the samples would cure. The samples did increase in weight by about 3-4%. These samples were placed in a water bath from 12 hours to 7 days. The weight change was measured.

All the samples were burned by a map gas torch for 90 seconds. There was no apparent difference in FR as the samples qualitatively with stood such an intense FR test as well as samples not subjected to the water bath.

It is also claimed here that the organo silanes could be mixed and melted together with DETAPPA in separate step.

Sample 56a consists of 60 SPUR 1015, 6 g Dynasylan 1146, and 6 g Dynasylan 6490. Sample 562 was prepared in a Brabender at 190 C set point by adding 102 g DETAPPA, 200 g general purpose ABS Cyclolac MG94U from Sabic Corp., 15 g Blendex 3160 from Galata Chemicals, 3 g Synfluid mpao 150, and 10 g of 56a. Plaques about 3/32 in thickness exhibited very good FR in that there were no dripping or sustained burning observed when exposed to 3-4 inch propane flame for up to one minute. The samples were very strong qualitatively. A 37.6 g plaque ⅛ inch thick increased its weight to 37.85 g when exposed to a humid environment for 12 hours. Thus, the sealant was found to enhance moisture resistance and FR behavior of ABS. A ⅛ inch thick plaque was placed in water for three days. The weight increase was 1.6%. Placed in an oven at 70 C, the weight increase was 0.2%. This same sample was placed in water bath for nine more days. After drying g the weight was nearly identical to the weight that went in. The small increase of 0.2% could be due to cross linking of the organo silanes.

Sample 56a was allowed to sit in air for about 2 days. A rubbery mass formed indicating that this combination cures without the need for a catalyst. A catalyst accelerates the rate of cure. Thus, the necessity for a catalyst might be averted by proper choice of organo silane combinations, especially as tin containing compounds have objectionable environmental effects. Non tin containing catalysts are available from Reaxis Inc, McDonald, Pa., 15057.

Sample 44a is prepared by mixing in a Brabender at 175 C 350 g DETAPPA, 1 g Dynasylan 1146, and 4.3 g Dynasylan 6490. Thermo set sample 428a is prepared by wet grinding 9 g TETA and 10 g sample 44a. This is then added to 44 g Epon 828 and cured in an oven for two hours at 90 C. The sample was subjected to UL94 testing at 1/16 inch and passed easily. Thermo set sample 428b is prepared by wet grinding 9 g TETA and 10 g DETAPPA. This is then added to 44 g Epon 828 and cured in an oven for two hours at 90 C. The sample was subjected to UL94 testing at 1/16 inch and passed easily.

Samples with a loading of DETAPPA of 50% or more tend to drip and sag when subjected to a flame, especially if the sample had been in water bath for at least two days. The high loading exacerbates the moisture sensitivity of the FR samples. The organo silanes were found to be an additive that 1) reduces bleed out and stickiness in a humid environment, 2) serves as a drip suppressant for compositions subjected to a flame, and 3) reduces DETAPPA from being washed out of compositions when subjected to a water bath. The use of vinyl silane and SPUR has enabled a doped DETAPPA that is water tolerant but still hydroscopic. DETAPPA has the property of liquefying if left out in air or put in water bath which organo silanes can stop.

The catalyst was used in samples formed with an extruder. A film 0.125 inch thick composed of the organo silane combination of 30 g SPUR 1015LM, 5 g Dynasylan 6490, and 5 g Dynasylan 1146 cured in air in 24 hours without a catalyst. A film 0.125 inch thick composed of the organo silane combination of 30 g SPUR 1015LM, 7 g Dynasylan 6490, and 1 g Dynasylan 1146 did not cure in air in 24 hours without a catalyst. This sample remained sticky and partially cured even after one week.

The conclusion is that the organo silanes especially if allowed to cure with catalyst are useful in improving the moisture resistance, drip suppression, and thus the overall FR performance without sacrificing good mechanical properties.

The use of these organo silanes is entirely different than using epoxy containing compounds (see U.S. application Ser. No. 14/117,427) to improve moisture resistance as epoxy containing compounds do not improve drip suppression in a flame. The organo silane epoxy containing compounds of this invention do enable drip suppressance when polymers containing such doped EAPPA compositions are subjected to a flame.

Another part of this invention is to form polymer compositions consisting of EAPPA and organo silanes added directly together with an extruder, thus omitting the expensive step of doping EAPPA with organo silanes. This is very likely to be the economical approach especially for formation of FR polymers at lower loadings where mixing is not as big an issue.

The sealant organo silanes can be added to thermosets and then cured.

The doped DETAPPA made with vinyl silane as in sample 44a can be ground to a fine powder in a liquid. The fine powder could be used in all applications. For thermosets, the monomer is often a liquid that is cured with a second component such as TETA and DETA. It is usual to use a solvent to enable to lower the viscosity. Thus, wet grind the doped DETAPPA in the appropriate solvent or wet grind in the solvent with the monomer. Then form the FR thermoset by adding the components and then removing the solvent. Epon 828 by Momentive Performance would be an example of this technology.

Sample 527a is obtained by mixing together 40.5 g Spur 1015LM, 5.7 g Dynasylan 6490, and 0.6 g Dynasylan 1146. Next, 34 g of this organo silane mixture was melted into 350 g DETAPPA to form sample 527a.

Epoxy FR example: 16 g of Epon 828 is heated to 125 C in a mortar and pestle in an oven. Four g of sample 527A was then added to the hot Epon 828 and milled for five minutes at which time 2.1 g TETA was added and mixed with no sign of particles. The sample was returned to the oven for five minutes at which time it had hardened/cured to a glossy finish. A second sample was made by the identical procedure: 17 g Epon 828, 4 g sample 527a, and 2.6 g TETA with a very similar behavior. Both samples pass UL94 at ⅛ inch thickness. Sample 27a was found to crumble easily. The Brabender beaters were easy to clean as the sample stickiness was quite low. Sample 527a left in air for 5 days did not become sticky or liquefy. It did absorb approximately 10% water from air. Both samples are not clear indicating that the curing causes some color centers to form.

Mixing together 40.5 g Spur 1015LM, 5.7 g Dynasylan 6490, and 0.6 g Dynasylan 1146 results in sample A that cures very slowly in air taking at least three days. Sample B formed by mixing together 40.5 g Spur 1015LM, 6 g Dynasylan 6490, and 6 g Dynasylan 1146 begins to cure in air in about two hours. Twenty grams Sample A melted together with 350 g DETAPPA resulted in a product that crumbles easily , not very sticky, and does not liquefy left in air. Twenty grams Sample B melted together with 350 g DETAPPA resulted in a product that is polymeric like, quite sticky, and very slowly liquefies left in air after seven days or so.

Epoxy clear FR example: 16 g of Epon 828 is heated to 125 C in a mortar and pestle in an oven. Four g of DETAPPA was then added to the hot Epon 828 and milled for five minutes at which time 2.1 g TETA was added and mixed. The mixture did not appear to contain particles. The sample was returned to the oven for five minutes at which time it had hardened/cured to a glossy finish. The sample was clear or transparent. A second sample was made by the identical procedure: 17 g Epon 828, 4 g sample 527a, and 2.6 g TETA with a very similar behavior and transparent. A good application is transparent fire resistant glass formed by placing clear FR epoxy sheets between alternating sheets of glass. A 70% transparency is required at a minimum which these samples achieve.

The polymers both thermoset and thermoplastic for which the doped DETAPPA of this invention can be used have been listed in U.S. Pat. No. 7,813,443 and 8,212,073. PVC is excluded.

Sample FR PP: Sample 519a was formed by mixing together 60 g SPUR 1015LM, 6 g Dynasylan 1146, and 6 g Dynasylan 6490. Sample 5191 was formed by mixing in a Brabender, 90 g DETAPPA, 18.4 g sample 519a, 145 g of medium viscosity polypropylene (PP), 111 g calcium carbonate, 4.2 g PAO, and 7 g Elvaloy PTW. Sample 5192 was formed by mixing in a Brabender, 9 0g DETAPPA, 17.7 g sample 519a, 145 g of medium viscosity polypropylene (PP), 105 g fine ground sand, 4.9 g PAO, and 7 g Elvaloy PTW. Both samples had good flexibility and passed UL94 VO at ⅛ inch. Both PP samples left on a porch for 7 days during high humidity period of time did not become sticky. Sample 5191 saturated water gain on porch was 1.7% whereas sample 5192 saturated/gained 1.9%. Two new samples were left in water bath for 5 days to investigate leaching. Sample 5191 weighed 0.5% more than its initial weight. Sample 5192 weighed 0.9% more than its initial weight. Thus, the organo silane technology enables FR PP samples with good behavior in air and a water bath.

Sample 527a: A mixture of 40.5 g Spur 1015LM, 5.7 g Dynasylan 6490 and 0.57 g Dynasylan 1146 was formed. Sample 527a was formed by melting together in a Brabender 34 g of 527a with 350 g DETAPPA. In an oven at 125 C, a mortar pestle was heated. Mortar was removed. To the was added 16 g Epon 828, 4.1 g 527a and ground for 5 minutes. Then, 2.12 g TETA was added and then place in oven for 8 minutes for curing to form sample 5271. Sample 5272 was formed identically except 17 g Epon 828, 2.62 g TETA, and 4 g 527a. Both samples were very shiny. Both passed UL94 V0 at ⅛ inch thickness.

Sample 528a was formed by mixing 30 g SPUR 1015LM, 0.9 g Dynasylan 1146, and 5.1 g Dynasylan 6490. Sample 5281 was formed in a Brabender by mixing 180 g DETAPPA, 48g100J, 105 g Elvax 260, 7 g Elvaloy PTW, 20 g 528A, 4 g PCE, and 3.3 g Accel T. A 1/16 inch thick sample was left in air for two days to cure as 7.8% increase in weight was measured. A strip of 5281 was subjected to a two inch Bunsen burner flame for 3 minutes. The sample did not drip or sustain a flame at 30 second intervals where flame was taken away. Sample 528a cures very slowly in air, remaining a little sticky after two days but partially cured as viscosity significantly increased.

Example 812a. In a high speed mixer, 500 g of DETAPPA is ground with 10 g of Synfluid 150. A few batches were made.

Example 8181 In a Brabender, a composition is made consisting of 102 g Elvax 260, 7 g Elvaloy PTW, 7 g Spur 1015, and 180 g 812a. This sample became sticky in very humid environment. When it was remade (sample 8191) adding 14 g PTW, reducing EVA by 7 g, and adding 7 g PAO, the sample did not get sticky at 95% humidity and room temperature for 48 hours. Adding a curing agent for the SPUR would also have helped.

Example 8192. In a Brabender, a composition is made consisting of 92 g Elvax 260, 15 g Elvaloy PTW, 7 g Spur 1015, and 180 g 812a. This sample did not become sticky in very humid environment that caused Example 8181 to become sticky. This example shows the importance of adding a polymer grafting agent to reduce stickiness. Adding curing agents could also stop stickiness but more difficult to achieve in a Brabender.

These examples have demonstrated that SPE silanes, SPUR silanes, amino silanes, epoxy silanes, and vinyl are dopants that are compatible with EAPPA and compositions containing EAPPA. These silanes are also found stable to extrusion with EAPPA compositions. The examples used hydrophobic fumed silica. The remaining examples (set B and set C) will show why hydrophilic fumed silica is preferred over hydrophobic fumed silica.

In previous patent PCT/US2015/065415, it is stated that hydrophobic fumed silica is preferred as drip suppressant in FR polymer compositions containing EAPPA. Fumed silica both hydroscopic and hydrophobic fumed silica and are very well defined in U.S. Pat. No. 8,703,853 and PCT/US12/000247. The preferred fumed silica in that work was hydrophobic Aerosil R972 by Evonik Corporation. It has been found that hydrophobic fumed silica creates issues with stickiness at loadings of about 2% by weight. For example, a sample composed of 100 g Elvax 260, 12 Elvaloy PTW, 4 g PAO, 180 g DETAPPA, 48 g FP2100J will have an LOI of about 48%. If about 6 g-7 g of Aerosil R972 is added to this composition, the LOI increases to about 60%-65%, a large improvement in FR due to fumed silica. However, such compositions have a substantial decrease in tensile strength and elongation. The samples with 2%-3% Aerosil R972 tended to get sticky in a humid environment. The dispersion was poor as a result of large content of FP2100J. It would be highly desirable to eliminate the use of particulate FR and use only EAPPA.

PAO behaves differently depending on type of fumed silica. PAO mixed with hydrophobic Aerosil R972 at 50%/50% ratio by weight would slowly separate indicating little reaction. PAO mixed with Aerosil 200 at 50%/50% ratio by weight does not separate indicating a strong reaction or attraction, even though PAO is insoluble in water. AEROSIL® 200 is a hydrophilic fumed silica with a specific surface area of 200 m²/g. Hydrophilic means that water wets Aerosil 200 but does not dissolve it. Water does not wet Aerosil R972. Aerosil 200 was used in many of remaining examples.

A drawback of organo silane use in FR polymer compositions is that the organo silanes are quite flammable and it is desirable to limit their use. They also degrade mechanical properties if a lot is used. It is expected that the hydroxyl function of hydrophilic fumed silica will react with organo silanes and facilitate curing. Organo silanes require moisture for curing. Instead of relying on the atmosphere, it is possible to add a moisture containing compound to organo silane containing compositions. Examples will now be reported whereby hydrophilic fumed silica is the apparent source of water for curing the organo silanes resulting in apparent crosslinking of polymer compositions containing EAPPA. Hydrophilic fumed silica will be shown to be an excellent anti-dripping agent, thereby serving duel role. Other hydroxyl compounds could work as well but might not be effective drip suppressants.

### Set B: Examples Showing Improvement in FR and Surface Migration Resistance by adding Hydrophilic Fumed Silica Enabling FR Content of 60% to 65 without the Need for Particulate FR

In all the examples, the method consists of first mixing one or more liquids chosen from the group of PAO and liquid organo silanes with the hydrophilic fumed silica Aerosil 200 (FS). Then, the treated hydrophilic fumed silica is mixed with the DETAPPA. The organo silanes are Dynasylan 1146 and Dynasylan 6490 and Silquest 187, which are labeled Dynasylan 1146, Dynasylan 6490, and Silquest 187, respectively. The polymers are Elvax 260, Elvaloy PTW and LDPE, melt flow of 11.

The next set of samples were all made on Brabender following the same procedure. First the polymer is added and melted. The other ingredients were mixed together and then added slowly to the Brabender. These examples demonstrate that LOI in the 60-70 range is achieved with different combination of FS (Aerosil 200), PAO and organo silanes and that a second FR additive is now unnecessary.

Example 8161: The composition consists of 7 g FS 200, 5.6 g Dynasylan 6490, 0.0 g Dynasylan 1146, 1.7 g Silquest 187, 3.5 g+4 g PAO, 200 g Elvax 260, 180 g PNS, 19 g FP2100. This composition contains 57% FR, LOI is 44, TS (PSI) 1057, elongation 232%, SG is 1.25.

Example 8162: The composition consists of 7 g FS 200, 3.7 g Dynasylan 6490, 4.6 g Dynasylan 1146, 1.6 g Silquest 187, 3.5 g+0.6 g PAO, 113 g Elvax 260, 180 g PNS, 0 g FP2100. This composition contains 57% FR, LOI is 60, TS (PSI) 1273, elongation 113%, SG is 1.33.

Example 8163: The composition consists of 9 g FS 200, 5 g Dynasylan 6490, 4. g Dynasylan 1146, 2 g Silquest 187, 3.5 g+5 g PAO, 113 g Elvax 260, 180 g PNS, 19 g FP2100. This composition contains 58% FR, LOI is 69, TS (PSI) 1019, elongation 53%, SG is 1.31.

Example 8164: The composition consists of 9 g FS 200, 9 g Dynasylan 6490, 0. g Dynasylan 1146, 2 g Silquest 187, 3.5 g+5 g PAO, 113 g Elvax 260, 180 g PNS, 1 9g FP2100. This composition contains 58% FR, LOI is 66, TS (PSI) 1281, elongation 82%, SG is 1.33.

Example 8165: The composition consists of 9 g FS 200, 0 g Dynasylan 6490, 9. g Dynasylan 1146, 2 g Silquest 187, 3.5 g+9.2 g PAO, 113 g Elvax 260, 180 g PNS, 19 g FP2100. This composition contains 58% FR. Sample is too brittle to measure.

Example 8171: The composition consists of 10.5 g FS 200, 7.4 g Dynasylan 6490, 2. g Dynasylan 1146, 2 g Silquest 187, 7 g+2.6 g PAO, 113 g Elvax 260, 200 g PNS, 0 g FP2100. This composition contains 58% FR, LOI is 44, TS (PSI) 1027, elongation 67%, SG is 1.29.

Example 8251: The composition consists of 9 g FS 200, 9 g Dynasylan 6490, 0. g Dynasylan 1146, 2 g Silquest 187, 5 g+6 g PAO, 113 g Elvax 260, 200 g PNS, 0 g FP2100. This composition contains 58% FR, LOI is ??, TS (PSI) 1027, elongation 67%, SG is 1.29.

Example 8252: The composition consists of 10.5 g FS 200, 7.4 g Dynasylan 6490, 2. g Dynasylan 1146, 2 g Silquest 187, 3.5 g+3 g PAO, 113 g Elvax 260, 200 g PNS, 0 g FP2100. This composition contains 60% FR, LOI is 70, flexible, strong.

Example 8271: The composition consists of 10.5 g FS 200, 7.4 g Dynasylan 6490, 2. g Dynasylan 1146, 2 g Silquest 187, 5 g+4 g PAO, 113 g Elvax 260, 200 g PNS, 0 g FP2100. This composition contains 60% FR, LOI is 70, TS (PSI) 1200, elongation 120%, flexible strong.

Example 8231: The composition consists of 10.5 g FS 200, 9 g Dynasylan 6490, 0. g Dynasylan 1146, 2.3 g Silquest 187, 8 g PAO, 90 g LDPE MF 11, 23 g PTW, 200 g PNS. This composition contains 59% FR, LOI is 49.

Example 8232: The composition consists of 8 g FS 200, 6 g Dynasylan 6490, 0. g Dynasylan 1146, 2 g Silquest 187, 8 g PAO, 137 g LDPE MF 11, 25 g PTW, 150 g PNS. This composition contains 45% FR, LOI is 49.

Example 8241: The composition consists of 2 g FS 200, 4 g Dynasylan 6490, 0. g Dynasylan 1146, 1 g Silquest 187, 5.9 g PAO, 120 g LDPE MF 11, 43 g PTW, 150 g PNS. This composition contains 45% FR, LOI is 34.

Example 8242: The composition consists of 4 g FS 200, 4 g Dynasylan 6490, 0. g Dynasylan 1146, 1 g Silquest 187, 8 g PAO, 120 g LDPE MF 11, 43 g PTW, 150 g PNS. This composition contains 45% FR, LOI is 30.

Example 1131: The composition consists of 9 g FS 200, 0 g Dynasylan 6490, 7.1 g PAO, 100 Elvax 260, 13 PTW, 200 g PNS pH 3.

Example 1132: The composition consists of 9 g FS 200, 0 g Dynasylan 6490, 7.1 g PAO, 100 Elvax 260, 13 PTW, 200 g PNS pH 4. LOI is 71.

Example 1141: The composition consists of 7 g FS 200, 4 g Dynasylan 6490, 7.1 g PAO, 190 Elvax 260, 23 PTW, 200 g PNS pH 3.

Example 1142: The composition consists of 7 g FS 200, 4.2 g Dynasylan 6490, 7.1 g PAO, 100 Elvax 260, 13 PTW, 200 g PNS pH 4. LOI is 68.

Example 1143: The composition consists of 7 g FS 200, 4 g Dynasylan 6490, 7.1 g PAO, 100 Elvax 260, 13 PTW, 200 g PNS pH 4. LOI is 64.

The samples 8161 to 8164, 8171 and 8251 indicate that an LOI in the 60%'s can be obtained while still retaining reasonable elongation and tensile strength. In U.S. Pat. Nos. 7,138,443; 8,212,073; 8,703,853 and US application No. 2006/0175587, PCT/US12/000247, and PCT/US15/65415, samples with 60% by weight DETAPPA were not reported. The LOI is as high as 70, an extremely high value. Without fumed silica, the LOI is in the 40's. Even more noteworthy is that polymer compositions with 60% DETAPPA are now possible that do not become sticky in air. Piperzine phosphate FP2100J is not preferred to be a part of the composition containing hydrophilic fumed silica, a major departure from previous literature.

Sample 8251 are sticky and brittle. Sample 8252 is very good, the only difference being a lesser amount of organo silane. Too much organo silane can result in brittle samples. Sample 8271 indicates that a loading of 60% DETAPPA is obtainable even without organo silanes if enough hydrophilic fumed silica is used. Sample 8165 became brittle because too much Dynasylan was added. Probably, too much cross linking did not allow DETAPPA to disperse properly causing it to get sticky in air. Brittle samples tend to become sticky in air readily. Thus, the conclusion is formed that hydrophilic fumed silica is preferred, especially for samples containing at least 50% DETAPPA by weight.

It is interesting that the LDPE sample 8231 with 58.5% DETAPPA did not become sticky in air. Apparently, Elvaloy PTW, organo silanes, and Aerosil 200 react with the DETAPPA to get a dispersion of DETAPPA that does not migrate to the surface. This is first reported sample of LDPE with 58.5% DETAPPA that does not get sticky in air. The LOI is 49 as the composition has a very slight melt at this concentration of DETAPPA as PE has no functionality. The introduction of organo silanes, hydrophilic fumed silica, and polymer with epoxy function to EAPPA/polymer FR compositions should be applicable to all polymers. The ideal proportions will depend on the polymer so as to avoid too much crosslinking. Hydrophilic fumed silica may decompose if the processing temperature is too high due to loss of water from the hydrophilic fumed silica. A person knowledgeable in this science should be able to find the right balance.

In previous applications, PCT/US12/000247, it was indicated that for a high loading of FR near 50% to 67%, the preferred amount of EAPPA is 22% to 57% by weight and 12% to 40% by weight of phosphorous flame retardant and it was also preferred to add the drip suppressant fumed silica at a loading of at least 0.25% and the preferred is hydrophobic Aerosil R972. All the highly filled FR examples in PCT/US12/000247 limited EAPPA to about 50%, FP2100J to about 14%, and Aerosil R972 to about 1.2%. Examples 8252 and 8271 are the first formulations with approximately 60% DETAPPA without the need to add a particulate FR. Such a high loading is due to the use of organo silanes and hydrophilic fumed silica. Substitution of Aerosil R972 resulted in samples that became slightly sticky in air within 24 hours at 90% relative humidity and temperature of 75° C. Samples such as 8271 have elongation and tensile strength at least 20% greater if Aerosil 200 is used instead of Aerosil R972.

Fumed silica both hydroscopic and hydrophobic fumed silica are very well defined in U.S. Pat. No. 8,703,853 and PCT/US12/000247. It was stated in U.S. Pat. No. 8,703,853 and PCT/US12/000247 that the preferred fumed silica for polymer compositions with EAPPA is hydrophobic Aerosil R972 by Evonik Corporation.

The LDPE samples 8231, 8232, 8241, 8242 do not become sticky in air due to hydroxyl content of Aerosil 200 and the organo silanes. The DETAPPA content is 58.5% and 45%. Vinyl silane was used as likely to react with LDPE end groups.

Samples 8271, 8252, 8241, 8242, and 8232 were placed in oven set at 74 C and humidity greater than 90% for 20 hours. The samples showed no sign of stickiness or surface migration despite high loading EAPPA.

Sample 8271 was made into a 40 mil plaque 3 inch by 3 inch. The sample was placed on a block of wood and subjected to a propane torch with a Benzomatic TS4000 head which has a temperature of about 3600° F. The plaque was horizontal and the torch was held about 5 inches from the sample for 5 minutes and no smell was noticed. There was no observable flame or smoke, very low smoke and very low flame. The sample 8271 charred on the surface but did not burn through and was still flexible after the sample quickly cooled. The wood was completely shielded by the thin 8271 plaque. This sample possessed ideal shielding properties or thermal barrier protection properties: low temperature underneath the sample, very low smoke, very low flame, no burn through for 5 minutes despite being subjected to 3600° F. torch.

By comparison, a similar PVC plaque, constructed from a PVC sample that passes the W&C plenum test UL 910 (NFPA 262), was subjected to the same flame. The plenum PVC burned immediately and converted to a thick, hard char and a terrible smell was released. The PVC did not display thermal barrier protection. The test was stopped after two minutes as the wood underneath the sample began to burn. This EVA sample with LOI 70 has the property of no visible smoke and no visible flame.

Thermal barrier property is exhibited by example 8271 but not the plenum pvc cable compound. Thermal barrier property was exhibited by example 8271 in that the wood substrate under the 40 mil plaque did not burn through even after five minutes application of a torch. The practical applications of thermal barrier polymers such as example 8271 are obvious: a wire and cable jacket protecting polyethylene (PE) coated wires, non burning siding for housing, and coating on flammable fuel tanks. Power cables constructed with one to four copper wires with PE insulation and a jacket of the high LOI flame retarded compositions of this invention will have at least 10% higher energy efficiency than copper wires insulted with PVC and with a PVC jacket. Communication cables with 4 pairs of PE coated copper conductors and the LOI 70 flame retarded compositions of this invention should pass UL910 plenum test and have the efficiency of FEP coated copped conductors.

A sample, made with the composition of 8231 except Aerosil R972 is substituted for Aerosil 200, becomes slightly sticky in air. The organo silanes must be used with care as it is possible to obtain compositions that are so cross linked that stickiness in air results, as in sample 8165 and 8251. A LDPE composition 8231 has similar composition to 8165 and 8251 but does not get sticky in air. Thus, compositions are different for different polymers. The experiments have shown that hydrophilic fumed silica is preferable as much less likely to become sticky in humid environment. It is also possible to cross link such compositions either by addition of chemical cross linked compounds or by electron beam treatment of polymers.

The difference of LOI of EVA samples of 8161, 8162, 8163, 8164, 8165, 8171, 8251, 8252, 8271versus LDPE samples 8231, 8232, 8241, 8242 indicates the choice of polymer is important and those knowledgeable in this field would know how to choose appropriate polymers. For example, EVA's with high VA content accept a lot of filler. PE is difficult to flame retard as no functionality.

Samples 1131, 1132, 1141, 1142, 1143 demonstrate high LOI. Sample 1132 with pH 4 PNS has LOI 71. The ratio of EVA to PTW is 10 and has LOI 71. The same composition made with a ratio of EVA to PTW of 8 had an LOI of 58. The LDPE samples will probably have a higher LOI if little or no PTW is used. Comparison of samples 1132 and 1142 shows that low pH PNS has lower LOI than that made with standard pH 4 PNS.

Attempts at making sample 1132 on a twin screw extruder (22 mm and 27 mm) and on a Buss kneader 55 mm were unsuccessful. Such a high loading of fumed silica (2.7% by weight of final composition) caused the samples to have poor dispersion and be brittle. Samples with a 2% loading could be made on a Buss Kneader but the LOI dropped to 55 which are quite acceptable LOI. It will be shown that incorporation of organo silanes on the fumed silica enabled an LOI of greater than 55%.

Samples with PNS loading of greater than 50% by weight are greatly affected by processing. Sample 1132 was made in a Brabender by first melting the polymer in the chamber and then adding PNS and the other ingredients. The mixing occurs very rapidly and that is our standard procedure for preparation of all Brabender samples. The mixing is very slow if the PNS is first melted and then the polymer is added. This suggests that for samples made with extruders, it is preferred to first melt the polymer in the first zone, and then add the PNS and hydrophilic fumed silica after the polymer has melted substantially such as at the input where chopped glass is normally added.

A Sample with similar composition to 1132 was made on a Buss Kneader 58 mm extruder with separate feeders at three feed ports. The EVA polymer was added in the first port at 40% by weight loading. The restricter ring is such that the polymer is fully melted before passing to the second port. The second feed port, located after the restricter ring, was used to feed 40% loading by weight of the non EVA ingredients (PNS, PAO, hydrophilic fumed silica) and a third feed port after that was used to add 20% by weight the non EVA ingredients (PNS, PAO, hydrophilic fumed silica). The result is polymer pellets that contain 40% polymer (EVA and PTW ratio of 10) and 60% non polymer ingredients (PNS, PAO, hydrophilic fumed silica) and very flexible and well mixed. The LOI was 50%. For a ratio of 36% polymer and 64% non polymer ingredients (PNS, PAO, hydrophilic fumed silica), it was necessary to add an additional 1% by weight Dynasylan 6490 or 1% by weight PAO with a further increase in LOI to 55 resulted.

The preferred production of polymer compositions with at least 40% by weight PNS and substantial FS is to first melt the polymer, then add the PNS and other ingredients to the melted polymer. Such capability exists on large extruders which have distributed feed ports. PNS and organic polymers have melting properties that interfere with melting and mixing together uniformly if added at same feed port at same time. This type of mixing could be used to add ingredients to EAPPA. For example, add EAPPA in first port with temperature so it is melted by the second port. At second and third ports add other ingredients such PAO, hydrophilic fumed silica, and Teflon 6C.

Hydrophilic fumed silica disperses better in EAPPA polymer compositions due to reaction of EAPPA and hydrophilic fumed silica. There is a driving force for EAPPA to melt around the hydrophilic fumed silica particles as drive to saturate the hydroscopic tendency. There is no such force with hydrophobic fumed silica such as Aerosil R972. Thus, for the first time, EVA samples can be loaded with 60% EAPPA and not require a particulate FR such as FP2100J, piperazine phosphate.

In PCT/US2015/065415, it is stated that fumed silicas are drip suppressants and that hydrophobic Aerosil such as Aerosil R972 is preferred. All the examples with high loading of FR also added piperzine phosphate. There is no mention of the use of hydrophilic fumed silica such as Aerosil 200 to improve surface migration resistance and drip suppressance, as reported here with examples. There is also no mention or claim of PAO to enable good dispersion of large amounts of fumed silica with EAPPA/polymer compositions. Elimination of FP2100J enables EAPPA/polymer compositions with better tensile strength and elongation and melt flow.

Organo silanes with epoxy, amino, and vinyl functionality can condense onto hydrophilic fumed silica as well as react with DETAPPA and polymer end groups. Such reactions reduce likelihood of migration of DETAPPA and also increase tensile strength without sacrificing flexibility.

### Set C: Examples Showing Improvement in FR and Surface Migration Resistance of Polymers Formed with Doped Ethyleneamine Polyphosphate Enabling FR Content of 60% to 65%, Very High LOI, and Production with an Extruder and No Dust Issues

The Brabender samples with LOI greater than 65 are difficult to produce on a twin screw extruder or a 58 mm Buss kneader because of limited time to add the low bulk density hydrophilic fumed silica and get good mixing. It is absolutely impractical to make flame retardant organic polymer compositions on a batch mixer as the compositions stick to stainless steel parts. The hydrophilic fumed silica is difficult to disperse at levels at 2% or greater of final polymer composition weight in extruders. It will now be shown how to make flame retardant compositions based on doped EAPPA and obtain LOI of at least 59. The problem of adding substantial amount of fumed silica to polymer compositions without dusting is solved with a new form of EAPPA (EAPPA-FS). These new compositions incorporating hydrophilic fumed silica enabled the formation of compositions on a twin screw extruder with an LOI of 66 to meet our target flammability and better surface migration resistance than that obtained with EAPPA.

Polyphosphoric acid/hydrophilic fumed silica is made by mixing hydrophilic fumed silica into polyphosphoric acid. A 3.3% loading by weight was chosen. PPA/FS looks like a gel. The FS quickly mixed easily and is very well dispersed. Hydrophobic fumed silica such as Aerosil R972 has very low solubility in polyphosphoric acid making the formation of polyphosphoric acid/hydrophobic fumed silica very difficult. Hydrophilic fumed silica with a high surface concentration of hydroxyls has very high solubility in polyphosphoric acid and very easy to make polyphosphoric acid/hydrophilic fumed silica. For example, 9 g of hydrophilic fumed silica Aerosil 200 disperses into 200 g of PPA 115% nearly instantly and does not settle out within months in a sealed container. PPA and Aerosil 200 mixed together gave off heat indicating a reaction and formation of a new doped PPA. Hydrophobic Aerosil R972 mixed very poorly with PPA 115%. For example, 9 of Aerosil R972 mixes only slightly with PPA 115%, with the great majority sitting above despite vigorous mixing. If mixed long enough in a heated Brabender, a powdered form of polyphosphoric acid/hydrophobic fumed silica was formed. In another experiment, one gram of R972 was mixed with 20 g PPA with a spatula. After determined mixing, a white fee flowing liquid formed. After about 60 minutes, the liquid became solid and could be broken apart into a crumbly somewhat pasty product, radically different from the very sticky product formed with PPA 115% and Aerosil 200.

Aerosil 200 coated with Silquest A1100 amino silane disperses in water and in polyphosphoric acid. Aerosil 200 coated with Coat a sil MP 200 epoxy silane disperses in water and in polyphosphoric acid. Aerosil 200 coated with Dynasylan 6490 vinyl silane or Dynasylan 1146 oligomer amino silane does not disperse in water or in polyphosphoric acid. Aerosil 200 coated with Dynasylan 6490 vinyl silane or Dynasylan 1146 oligomer amino silane does disperse easily into EAPPA-FS in a Brabender.

Substantial heat is released when PPA is mixed with Dynasylan 6490, Dynasylan 1146 or CoatOsil MP200 at a ratio by weight of ten parts PPA to one part organo silane to form another doped PPA. A doped PPA was also made with 20 parts PPA to one part Aerosil 200 coated with one part CoatOSil MP 200. These compositions appeared compatible with PPA for formation of doped EAPPA.

There does not seem to be a general rule as to which Aerosil 200 treated with organo silanes disperse in polyphosphoric acid or water. Aerosil 200 treated with organo silanes have been found to disperse into EAPPA-FS in Brabender. EAPPA-FS could be made with organo silane treated FS that is compatible in polyphosphoric acid.

### Method A to Form EAPPA-FS

Example R200 (DETAPPA-FS): The new composition containing ethyleneamine, polyphosphoric acid, and hydrophilic fumed silica can be prepared by the following method. The 10 liter Henschel mixer was heated to 400° F. Then, 1600 g of PPA 115% was added. Then add 80 g Aerosil 200 to the mixer and start mixing to from polyphosphoric acid/hydrophilic fumed silica, a 5% loading. After about two minutes as quite compatible, addition of ethyleneamine 735 g DETA occurred over a period of 12 minutes. After three more minutes, the product containing 3.3% by weight is drained out. The product was then subjected to vacuum heating in a vacuum oven at 245° C. for one hour, to a final vacuum of less than 0.5 mm Hg. The product was ground with 5.5 g of PAO added for every 500 g of FR product. A free flowing product resulted. The big advantage of this composition is that drip suppression is inherent to the new composition of matter. Because the polyphosphoric acid is bathed in hydrophilic fumed silica hydroxyls, the degree of moisture sensitivity is lower. This form with drip suppressant does not have dusting issues and no issues with adding to an extruder in polymer processing. Alternatively, condense PPA in this reactor with vacuum and a temperature 400° F. or greater and obtain the desired PPA molecular weight. Then, FS and DETA are added to form a high molecular weight product EAPPA-FS very efficiently. Degradation from condensation of EAPPA-FS will not occur in this alternate process since high molecular weight PPA was used and is inherent to the product.

A sample of DETAPPA was processed in identical manner to that of R200. The TGA of R200 differs from that of DETAPPA at temperatures greater than 400° C. R200 decomposes about 3% to 10% more rapidly from 500° C. to 700° C. indicating superior foaming. The char remaining at 850° C. is 44% for R200 and 35% for DETAPPA. They start to differ in thermal stability after 350° C. Both have the necessary thermal stability at 335° C. for processing into engineering polymers including polyphenylene sulfide (PPS).

It was unexpected that the reaction of EA and PPA could proceed despite the presence of hydrophilic fumed silica that was premixed with PPA to form a new gel like substance. Hydrophilic fumed silica is known to be hydroscopic. Despite the conditions of high acidity and high temperature, there do not appear to have been unwanted side reactions. Ethyleneamine and polyphosphoric acid reacted normally in the presence of high concentration of hydrophilic fumed silica. It was also unexpected that the addition of hydrophilic fumed silica did not impede substantially the removal of the melted product from the mixer. The product could have hardened at that temperature making production impractical. Fumed silica could have also have impeded the reaction and caused something unforeseen to happen.

The surface migration resistance of doped EAPPA is superior to that of EAPPA as absorbed water molecules need to displace the solvating effect of hydrophilic fumed silica. EAPPA-D has substantially higher molecular weight from embedded FS which further abates surface migration.

### Method B to Form EAPPA-FS

Example B200-9-9: Method B consists of forming DETAPPA in the reactor and then mixing in the Aerosil 200 into the melted EAPPA. It takes substantially longer for the Aerosil 200 to mix with the EAPPA making this a less preferred method over directly method A. Method B is for dopants not compatible with PPA.

However, dopants can be added in the reactor after EAPPA or doped EAPPA have been made as in method B. Similarly, dopants that might react with PPA could be added to the melted EAPPA in the reactor, method B.

### Example Piperazine Phosphate-D

Disperse Aerosil 200 in Orthophosphoric acid 96% grade. Neutralize with piperazine until pH 6 is reached. The experiment is performed in the Henschel mixer at 100° C. so that the highly exothermic reaction is contained. Extract product and dry. These piperazine phosphate-hydrophillic fumed silica compositions will be more effective than the compositions without FS as contain drip suppressant internally. A similar process can be used for other ethyleneamines.

Example nylon/EAPPA-FS/hydrophillic: A 22 mm twin screw extruder was set to run at 10 lbs. per hour and with set points at about 500° F. One feeder added nylon 66 (Zytel 101 from Invista Co., Wichita, Kans.) at a rate of 7 lbs. per hour. The other feeder added the EAPPA-FS/PAO/hydrophillic R200 at 3 lbs. per hour. The resultant strand was very tough as hard to cut with scissors, indicating that the toughness/strength property of nylon still retained despite high loading of 30% flame retardant. The pellets were solid with no sign of gassing from water being released. A strand about ⅛ inches in diameter was subjected to propane torch for one minute. There was substantial charring. There was a few seconds of sustained flaming after the torch is removed. This example shows the high thermal stability as extruded at 500° F. and inherently drip suppressant. The successful extrusion was surprising as hydrophilic fumed silica has hydroxyl content with the release of water being possible.

### Example EVA/PTW/EAPPA-FS/

First, Elvax 260 and Elvaloy PTW pellets were mixed at a ratio of 9:1, respectively, to from EVA91. Then in a brabender, 182 g of EVA91 were mixed with 150 g of R200 to from sample 1232. Sample 1233 was formed with 145 g of EVA91 and 145 g R200. Sample 1236 was formed with 145 g of EVA91 and 177 g R200. All three samples at 0.125 inch were very flexible and had very good bounce back when creased indicating an improvement in tensile strength compared to regular formulation with PNS.

Example 22 mm 5-5-1. For this sample, Aerosil 200 is coated with equal parts by weight of oligomer vinylsilane Dynasylan 6490. The amount of 940 g of New DETAPPA-FS (sample R200 above), 640 g of regular DETAPPA, was ground with 80 g of Aerosil 200 coated with Dynasylan 6490 (equal parts by weight hydrophilic fumed silica and vinyl silane) to a powder, form a FR composition. Using a 22 mm twin screw extruder with two feeders, composition was formed with 65% by weight just described FR composition and 35% by weight polymer consisting of 10 parts Elvax 260 to one part Elvaloy PTW. A beautiful strand was formed. This composition had an LOI of 66, tensile strength greater than 1400 PSI, and elongation greater than 100%.

A second sample was run with the same composition except that PNS and vinyl silane coated Aerosil 200 were substituted for new DETAPPA R200 so that the same ratios are obtained. The sample was sticky and brittle coming out of the extruder. Thus, it was essential to use the EAPPA-FS R200 to obtain these highly loaded compositions.

Finally, the best sample is made by only using DETAPPA-FS and not adding DETAPPA.

Example 22 mm 6-11-2. For this sample, Aerosil 200 is coated with equal parts by weight of oligomer vinylsilane Dynasylan 6490. The amount of 600 g DETAPPA-FS (sample R200 above), 30 g of Aerosil 200 coated with Dynasylan 6490 (equal parts by weight hydrophilic fumed silica and vinyl silane), and 9 g PAO were ground to a powder to form a FR composition. Using a 22 mm twin screw extruder with two feeders, composition was formed with 65% by weight just described FR composition and 35% by weight polymer consisting of 10 parts Elvax 260 to one part Elvaloy PTW. A beautiful strand was formed that has a hydrophilic fumed silica concentration of 3.6%. Such a high concentration is not possible without using EAPPA-FS only. Pellets were allowed to cure in air for two days. This cured composition had an LOI greater than 65, tensile strength greater than 1500 PSI, and elongation greater than 150%. This example demonstrates a practical approach to manufacturing compositions with very high LOI and good mechanical properties. Utilizing the new EAPPA-FMO enables to easily incorporate more hydrophilic fumed metal oxides into compositions. There is strong correlation between adding hydrophilic fumed metal oxides and getting higher LOI properties, LOI=65 for this example at 65% concentration and LOI=60 at 60% concentration. Such high level of hydrophilic fumed silica would otherwise not be practical.

Another sample was run with nylon 6. The polymer feeder consisted of 10 parts nylon 6 for each part by weight Elvaloy PTW at a rate of 7 lbs. per hour. The FR feed consisted of sample R200 plus 15 parts Aerosil 200 coated with Coat o Sil MP 200 (equal parts by weight) at a rate of 3 lbs. per hour. An excellent strand was observed but no physical or FR properties were measured. The strand was very tough and could not be cut with scissors.

Example 71350 with nylon 12 (PA12 Rilsamid Amno MED from Arkema, King of Prussia, Pa.) on 22 mm extruder: One feeder contained PA 12 and Elvaloy PTW at ratio 10:1.5, respectively, and 5 lbs. per hour feed rate. The second feeder contained R200 and Aerosil R512 at a ratio of 300 to 20 by weight, respectively, and feed rate 5 lbs. per hour. A beautiful strand and pellets were obtained. The LOI was 47, the tensile strength was 2389 psi, and the elongation was 135%.

Example 7133 with nylon 12: One feeder had nylon 12 at 6 lbs. per hour and no Elvaloy PTW. The second feeder was run at 4 lbs. per hour and contained the intimately mixed mixture: 300 g R200, 20 g Dynasylan 1146, 20 g Aerosil 200. The loi was 38%, tensile strength 3273 PSI, and elongation 98%.

Example 7131 with nylon 12: One feeder had nylon 12 at 6 lbs. per hour and no Elvaloy PTW. The second feeder was run at 4 lbs. per hour and contained the intimately mixed mixture: 300 g R200, 20 g Coat o sil MP 200, 20 g Aerosil 200. The loi was 34%, tensile strength 3373 PSI, and elongation 180%.

Example 71318 with nylon 12: One feeder had nylon 12 at 6 lbs. per hour and no Elvaloy PTW. The second feeder was run at 4 lbs. per hour and contained the intimately mixed mixture: 400 g R200, 15 g Coat o sil MP 200, 15 g Aerosil 200, and 20 g Tegopac 150. The loi was 32%, tensile strength 3048 PSI, and elongation 272%.

Thus samples of nylon 12 were successfully processed without Elvaloy PTW or PAO. It is possible that liquid organo silanes have some capability to lubricate.

HDPE HIVAL 506060, Mi 7 example: On a twin screw extruder, one feeder contained HDPE mix (ratio 10 parts HDPE to 1.5 parts Elvaloy PTW by weight) operated at 5 lbs. per hour. The other feeder was run at 5 lbs. per hour and contained R200 ground with Aerosil 200 coated with Dynasylan 6490 (equal parts by weight of each) at ratio 300:15. The strand was very polished and strong and flexible. The sample did not get sticky in high humidity. LOI=40%. Same procedure with LDPE gave a good strand with LOI=41%.

Finally, samples were made with DETAPPA-FS using organo silane to enhance mixing and PAO is not used.

Example 10221: Mix Elvax 260 and Elvaloy PTW together at a ratio of 8 to 1, respectively. Grind together 3 g Aerosil 200, 10 g Dynasylan 6490, and 217 g of R200 and call it sample H. To a Brabender was added 113 g of the polymer mix and 220 g of the just defined sample H. The sample exhibited very good flexibility and the FR was excellent. Here it is found that PAO no longer needed as a lubricant to obtain high loading of PNS-D (DETAPPA-D) in polymer compositions. Dynasylan 6490 is a more preferred lubricant for a composition with high loading of R200. This result shows that organo silanes could be even more preferred in obtaining polymer compositions with very high loading of flame retardant.

Example 10222: Mix Elvax 260 and Elvaloy PTW together at a ratio of 8 to 1, respectively. Grind together 5 g wood flour, 10 g Dynasylan 6490, and 217 g of R200 and call it sample I. To a Brabender was added 113 g of the polymer mix and 220 g of the just defined sample I. The sample exhibited very good flexibility and the FR was excellent. Wood flour is an alternative drip suppressant to Aerosil 200 and PAO was not necessary.

Example 1022 3, an FR WPC: To a Brabender set at 172° C., add 70 g of a mixture of Nova HDPE and Elvaloy PTW at a ratio of 8:1, respectively. Then 140 g R200 was added. Then 90 g wood flour was added. The final product released from beaters without any stickiness. The final composition had excellent FR. Strips ⅛ inch thick and 0.5 inch in width easily passed 3 10 second burns from below with a propane Bunsen burner with a one inch flame. This example was put forth as an example of a wood plastic composite (WPC) with very high level of flame retardancy. No lubricant was required for dispersion.

Example 1019 5, a control WPC. To a Brabender set at 172° C., 84 g Nova HDPE, 124 g wood flour, and 8 g PAO were added. The sample was pressed into strips ⅛ inch thick and 0.5 inch in width. The strips burned on first exposure of the flame. There is a huge difference in the WPC samples 1022 3 and 1019 5 (control).

Example 1022 4: The ratio of R200 to HDPE in sample 1022 3 is 36% R200 to 64% HDPE. A sample was run on the Brabender composed of 36% RF200 and 64% Nova HDPE. The sample was pressed to strips same dimension as in example 1022 3. These samples did not pass the vertical burn test of example 1022 3 and thus the FR was poor. The wood flour even though it burns rapidly is critical to FR performance of sample 1022 3.

Example 1022 5: A sample is prepared consisting of 64% nylon 6 and 36% DETAPPA containing 0.5% Dynasylan 1146, relative to DETAPPA weight. This FR nylon sample is spun into fiber. The FR nylon fiber filaments are converted to chopped fibers about 1.25 inches in length. Yarn is prepared consisting of 50% cotton fibers and 50% chopped FR nylon fibers. The yarn is used to make a fabric. The fabric passes 4 inch fabric vertical burn test. A similar fabric made of yarn consisting entirely of FR nylon chopped (no cotton) fibers fails the 4 inch vertical burn test for fibers. The interpretation is that the cotton fibers serve as a drip suppressant to keep FR nylon fibers to keep from burning as a single mass. Such behavior was observed in sample 1022 3 with wood flour separating FR HDPE into domains that prevented burning as a single mass. Sample 1022 4 burns as a single mass and fails FR testing.

The composition R200 was dissolved in water at 1:1 ratio by weight. In less than three weeks a transparent gel formed with a dark red color. A gel does not form when DETAPPA dissolved in water at same ratios, instead a syrup formed. Also, the fumed silica did not separate and was obviously suspended or embedded throughout the matrix. These results indicate the role of hydrophilic fumed silica in altering the properties of EAPPA consistent with inherent reaction and evidence of a new composition of matter. There is no apparent way to separate the hydrophilic fumed silica and obtain the syrup obtained with EAPPA.

The reaction of PPA 115% with organo silanes at ratio of 9:1, respectively, released even more heat than that with FS indicating an even stronger reaction. The reaction of PPA 115% with SPUR 1015LM and Tego Pac 150 form very viscous mass suggesting a polymeric nature. Reaction product of PPA 115% with Dynasylan 1146, Dynasylan 6490, and CoatoSil M200 is not as viscous but much heat was released. The reaction of Aerosil 200 and PPA 115% actually becomes nearly transparent indicating how well the hydrophilic fumed silica disperses. The reaction of Dynasylan 6490 eventually forms a nearly transparent polymeric like substance. The substance does not flow at room temperature. The substance becomes a solid mass that is preserved in air, although some moisture is absorbed from air.

Chopped cotton fibers of average length about 3 mm are obtained from Finite Fibers Co. Akron, Ohio.

Example cotton reinforcement: Grind together 200 g R200, 2 g chopped cotton average length 3 mm from Finite Fiber, and 6 g PAO. In a Brabender at 173 C, add 101 g Elvax 260 and 11 g Elvaloy PTW. Then the ground mixture was added and mixed together. The FR composition was extracted. Part of the composition was made into a 4×4 sheet about 60 mils thick. A propane torch was applied for 5 minutes at a distance of 4 inches and waved over the entire sample continuously. The sample did not suffer burn through. Thus, this sample with chopped cotton substituted for hydrophilic fumed silica displayed the property of thermal insulation or thermal barrier protection in addition to flame resistance.

In a Henchel mixer, the mixture 2300 g R200, 42 g Aerosil 200, and 55 g PAO was ground to fine powder. Elvax 260 and Elvaloy PTW were mixed at ratio 10:1 and 10:10 respectively. On a 22 mm twin screw extruder, the FR composition was fed at a rate of 6.5 lbs. per hour. The polymer blend was fed in another feeder at rate of 3.5 LBS. per hour. The strand was brittle for the 10:1 polymer blend. The strand was perfectly flexible for a 10:10 blend as well as for a run with all Elvaloy PTW. These blends appeared to have the property of thermal barrier insulation as no burn through when a torch is applied for 5 minutes. These experiments show the role of a compatibilizer Elvaloy PTW to obtain large loading of FR package.

### Experiment Demonstrating Effect of Draw and Moisture on Tensile Strength and Elongation

In the construction of a polymer jacket over insulation coated copper wires, a bead out of the extruder is continually placed on the copper wires and drawn or stretched to form a continuous jacket over the wires. The draw is several hundred % and causes the molecular chains to align making the polymer jacket have increased tensile strength in the direction of the draw. This draw effect is particularly important for polymer compositions containing EAPPA as the EAPPA molecular chains are aligning with the polymer chains. Polymer samples containing EAPPA absorb moisture from air. This moisture causes the molecular chains to slide past one another more easily making the samples much more flexible or plasticized.

For a 22 mm twin screw extruder, one feeder was operated at 5.0 lbs./hr. containing Elvax 260 and Elvaloy PTW mixed at a 9:1 ratio. The second feeder at 5.0 lbs./hr. contained a blend of 1.8% PAO, 0.9 Aerosil 200, and 97.3% R200. Strands from an extruder inherently contain draw of at least 100% as the strand was pulled from the extruder. The strands were collected from the extruder and cut into 5 inch long lengths. The strands were oriented in one direction and a plaque 0.055 in thickness was pressed. Tensile bars were prepared in the strand direction. The tensile bars contain draw in that the molecules of the polymer and R200 are partially aligned in the bar direction. The bars were subjected to 50% humidity for 40 hours. The average tensile strength was 1440 PSI and the average elongation was 362%. A sample processed from pellets and not having any draw had lesser properties. The tensile strength was 1300 PSI and the elongation was 220%. A sample not subjected to humidity or draw had tensile strength of 1200 PSI and elongation of 170%. The same experiment was repeated except at a ratio of 40% FR blend and 60% EVA/PTW blend. After plasticization, the average TS is 1867 PSI and average elongation is 377.

The orientation of molecular chains with draw and the plasticization with moisture both contribute to improving tensile strength and elongation and is a general property of flame retardant polymer compositions. This effect is found in other polymers containing EAPPA such as PE, EVA, and polyamides (nylon). The inherent property of polymer compositions containing EAPPA is that moisture plasticizes them to improve the strength and flexibility in a very desirable method as is well known for polyamides.

Thus, samples with EVA and PTW as the polymer subjected to draw and plasticization with moisture will have tensile strength and elongation at least 20% greater than samples with no moisture and not subjected to draw. It is preferred that polymer pellets or compositions containing EAPPA be subjected to relative humidity of at least 25% for at least 20 hours. It is more preferred that polymer pellets or compositions containing EAPPA be subjected to relative humidity of at least 50% for at least 10 hours. It is preferred that polymer compositions containing EAPPA for wire and cable jackets be subjected to draw of at least 200%. It is more preferred that polymer compositions for wire and cable jackets containing EAPPA be subjected to draw of at least 300%.

Experiment concentrate: In a Henchel mixer, 2300 g R200, 42 g Aerosil 200, and 55 g PAO was ground to fine powder. On a 22 mm twin screw extruder, the FR composition was fed at a rate of 6.7 lbs. per hour. Elvaloy PTW was fed in another feeder at rate of 3.3 LBS. per hour. The strand was flexible and strong. This composition will now be used as a concentrate to facilitate formation of FR polymers for polymers that do not accept much filler such as fractional melt EVA and PE.

The FR additive will be a powder of (2300 g R200, 42 g Aerosil 200, 55 g PAO). To obtain a 65% FR load, one feeder has the polymer composition consisting of the concentrate and 200 g Elvax 260 and the second feeder uses 366 g R200. Such ratio ran easily on a 22 mm producing a good strand. To obtain a second 65% FR load, feeder one has the polymer composition consisting of 100 g of the concentrate and 250 g Elvax 260 and the second feeder uses 458 g R200. Such ratio ran easily on a 22 mm producing a good strand. To obtain a third 65% FR load, feeder one has the polymer composition consisting of 100 g of the concentrate and 300 g Elvax 260 and the second feeder uses 551 g R200. Such ratio ran easily on a 22 mm producing a good strand. Thus, a concentrate enables production of highly filled polymers that cannot be done directly. Elvaloy PTW has been found to be compatible with many polymers and thus is a universal compatibilizer for halogen free polymers. To obtain a 30% FR loading, a mixture of 100 g concentrate and 300 g a second polymer such as nylon in first feeder and 75 g R200 in second feeder. A very good strand is produced. One could place 150 g concentrate and 183 g of second polymer to produce a 30% loading without using a second feeder for R200.

Melamine polyphosphate is claimed to be formed by heat treating melamine phosphate, the ratio being one melamine per phosphate. Melamine begins to sublime at about 265° C. Thus, by heating PPA and melamine to high temperature near 265° C. and simultaneously mixing with no water of solvent present, it is possible to form a PPA doped with melamine, PPA-M. The PPA-M can then be washed to eliminate unreacted PPA to form melamine polyphosphate. Thus flame retardant melamine doped PPA is claimed comprising the reaction of PPA and the dopant melamine without water or solvent and at a temperature that causes the melamine to sublime and mix into PPA and at any ratio up and including 1:1 as in melamine phosphate. It is essential to keep the reaction free of water to prevent of degradation of PPA.

Experiment Urea polyphosphate: Add 1660 g PPA 115% and 80 g urea to Henschel mixer at 396° F. Then add urea and follow standard procedure. The amount of urea is such that the product has pH of at least 4.

Condensing PPA by subjecting PPA to heat and vacuum increases molecular weight directly and easily. The highest molecular weight of PPA that is still easy to work with is PPA 115%. Higher molecular weight PPA 117% is available but difficult to work with unless heated substantially. By condensing PPA, even higher molecular weight can be obtained and used directly without cooling down. This condensed PPA is reacted with EA in a standard procedure to obtain directly a form of EAPPA that can directly be used in polymers. PPA 115% has a boiling point of about 500° C. It is preferred that the PPA been condensed to higher molecular weight so that the DETAPPA obtained has a weight loss less than 1% at 300° C. measured with TGA. It is more preferred that the weight loss be less than 1% at 325° C. requiring even a higher degree of condensation of PPA. The most preferred is a weight loss of less than 1% at 350° C. which requires even more condensation of PPA to remove water of condensation. Use of condensed PPA represents a more efficient manner to obtain EAPPA and doped EAPPA directly suitable for flame retardant polymer compositions without condensation of EAPPA. This method eliminates the degradation that EAPPA can suffer during condensation when exposed to high temperature and vacuum for long periods of time as indicated by reduction pH.

Polymer compositions containing the EAPPA-FS have better viscosity than those with regular EAPPA. The flame resistance is better as the EAPPA-FS inherently contains a drip suppressant and regular EAPPA does not. Use of EAPPA-FMO for flame retardant compositions is preferred over EAPPA, except for FR fiber applications. EAPPSA-FS is more preferred for flame retardant compositions. It is preferred that EAPPS-FS contain at least 0.5% by weight FS. It is more preferred that EAPPS-FS contain at least 1.5% by weight FS. It is most preferred that EAPPS-FS contain at least 2.5% by weight FS.

For making flame retardant polymers for fibers, it is preferred to use EAPPA-D where D is an organo silane that is compatible in PPA. Dopant cannot be a solid particulate that prevents spinning such as hydrophilic fumed metal oxides. It is more preferred to use a composition comprising a polymer, EAPPA, and organo silanes.

Ethyleneamine polyphosphate-hydrophilic fumed metal oxide is preferred to have a pH greater than 3 and less than 6.5. More preferred is pH from 3.5 to 5.5. The most preferred pH is 3.8 to 5. The same pH ranges for other dopants as well even if added to the melt after completing reaction of EA and PPA.

The preferred organo silanes are SPUR, amino silane, epoxy silane, and vinyl silane. It is more preferred to mix these silanes with hydrophilic fumed silica to form organo silane treated hydrophilic fumed silica. The most preferred is to mix organo silane treated hydrophilic fumed silica with EAPPA-FS and add to flame retardant polymer compositions. An organo silane curing agent is added as the flame retardant polymer composition is being made into a final form such as wire and cable jacket or molded parts. The examples show the conditions and concentration under which SPUR, amino silane, epoxy silane, and vinyl silane are compatible in this technology with EAPPA and PPA.

The preferred flame retardant polymer for non fiber applications comprises: 1) 20% to 96% percent by weight polymer; 2) 80% to 1% by weight ethyleneamine polyphosphate-hydrophilic fumed silica; 3) 3% to 0.1% by weight of hydrophilic fumed silica, and 4) PAO as lubricant. It is preferred this composition additionally contain 0.2% to 15% polymer grafting agent polymer relative to weight of polymer. Polymer grafting agent has been found to always boost moisture resistance and is always used in our applications. It is more preferred that FR polymer compositions contain at least 0.5% by weight hydrophilic fumed silica including the amount in the EAPPA-D. More preferred is 1.75% and most preferred is at least 2%. If more moisture resistance is necessary, it is preferred to substitute organo silanes for poly alpha olefin.

The new flame retardant EAPPA-D has inherent drip suppressant properties and eliminates dusting issues and extrusion issues with very low bulk density FS. Hydrophillic fumed silica easily mixes with PPA, EAPPA, and EAPPA-D whereas hydrophobic fumed silica does not mix easily. As a result, flame retardant polymer compositions can be made with very high loading of flame retardant EAPPA and EAPPA-D without needing a particulate flame retardant. These dopants also improve moisture resistance so that the use of polymer grafting agent is optional.

A rationalization has been proposed based on experimental observations, well after discovery. The claims do not rest on any theory or rationalization.

We claim:

1. A flame retardant composition prepared according to a reaction of ethyleneamine with polyphosphoric acid that has been subjected to condensation and with a ratio of polyphosphoric acid to ethyleneamine chosen so that the pH of a 10% aqueous solution by weight of the resulting flame retardant composition is at least 2.7.

2. A flame retardant composition prepared according to a reaction of ethyleneamine with doped polyphosphoric acid formed by reacting polyphosphoric acid or condensed polyphosphoric acid with one or more dopants chosen from the group consisting of polyalpha olefin, hydrophilic fumed metal oxides (FMO), nanocomposite, chopped aramid fibers, wool fibers, epoxy, and organo silane, and the dopants have the property of being compatible in polyphosphoric acid or condensed polyphosphoric acid, and with a ratio of doped polyphosphoric acid to ethyleneamine chosen so that the pH of a 10% aqueous solution by weight of the resulting flame retardant composition is at least 2.7.

3. The flame retardant composition according to claim 2, wherein the dopant is selected from the group consisting of hydrophilic fumed silica and organo silane treated hydrophilic fumed silica.

4. The flame retardant composition according to claim 2, wherein the dopant is hydrophilic fumed silica and the ethyleneamine is selected from the group consisting of ethylenediamine (EDA), diethylenetriamine (DETA), piperazine (PIP), triethylenetetramine (TETA), tetraethylenepentamine (TEPA), and pentaethylenehexamine (PEHA).

5. The flame retardant composition according to any one of claims 2-4, wherein the flame retardant composition is subjected to condensation.

6. A method for preparation of the flame retardant composition of claim 2 comprising forming doped polyphosphoric acid by mixing either polyphosphoric acid or condensed polyphosphoric acid with at least 0.1% by weight relative to the doped polyphosphoric acid one or more dopants chosen from the group consisting of polyalpha olefin, fumed metal oxides (FMO), nanocomposite, epoxy, and organo silane, and with the dopants having the property of being compatible with polyphosphoric acid and then reacting the doped polyphosphoric acid with an ethyleneamine (EA) at a reaction ratio and at a temperature without solvents so that the reaction of EA and doped polyphosphoric acid goes to completion.

7. A method for preparation of the flame retardant composition of claim 2, comprising forming ethyleneamine polyphosphate by mixing either polyphosphoric acid or condensed polyphosphoric acid with ethyleneamine at a reaction ratio and at a temperature without solvents so that the reaction of EA and polyphosphoric acid goes to completion and then adding at least 0.1% by weight relative to ethyleneamine polyphosphate one or more dopants chosen from the group consisting of polyalpha olefin, fumed metal oxides (FMO), nanocomposite, chopped aramid fibers, natural fibers, epoxy, and organo silane and a temperature maintained that the composition is in the melted state.

8. The method according to claim 6 or 7, wherein the dopant is selected from the group consisting of hydrophilic fumed silica and organo silane treated hydrophilic fumed silica.

9. The method according to claim 6 or 7, wherein the dopant is hydrophilic fumed silica and the ethyleneamine is selected from the group consisting of ethylenediamine (EDA), diethylenetriamine (DETA), piperazine (PIP), triethylenetetramine (TETA), tetraethylenepentamine (TEPA), and pentaethylenehexamine (PEHA).

10. The method according to any one of claim 6 or 7, wherein the flame retardant composition is subjected to condensation.

11. A flame retardant polymer composition comprising:
a) A polymer
b) One or more flame retardant compositions according to claims 1-5.

12. The flame retardant polymer composition according to claim 11, wherein the flame retardant polymer is a thermoplastic and the composition additionally contains one or more additives preferably in an amount of at least 0.1% by weight with respect to the final weight selected from the group consisting of 1) polymer grafting agent; 2) polyalpha olefin; 3) an anti drip compound chosen from the group consisting of hydrophilic fumed silica, nanocomposite, organo silane hydrophilic treated fumed silica, chopped natural fiber, chopped aramid fiber, chopped cotton, chopped wool, wood flour, and an organo silane containing compound.

13. A fiber plastic composite consisting of at least 30% to 65% by weight the flame retardant polymer composition of claim 11 or claim 12 and 70% to 35% one or more additives selected form the group consisting of wood flour, wood fibers, aramid fibers, and natural fibers.

14. A flame retardant polymer composition with the property of thermal barrier protection by requiring the flame retardant polymer composition of claim 11 or claim 12 to contain sufficient amount of the flame retardant composition of claims 1-4 to have a limited oxygen index (LOI) greater than 32.

15. A method for preparation of doped ethyleneamine phosphate, comprising reacting ethyleneamine with doped ortho-phosphoric acid of at least 85% grade by mixing the acid with at least 0.1% by weight relative to the acid one or more dopants chosen from the group consisting of fumed metal oxides (FMO) and organo silane, and then reacting the doped acid with an ethyleneamine (EA) at a reaction ratio and at a temperature so that the reaction of EA and doped ortho-phosphoric acid goes to completion.

16. A method for preparation of doped melamine polyphosphate or urea polyphosphate, comprising reacting melamine or urea with doped polyphosphoric acid formed by mixing the acid with at least 0.1% by weight relative to the doped acid one or more dopants chosen from the group consisting of fumed metal oxides (FMO) and organo silane, and then reacting the doped acid with melamine or urea at a reaction ratio and at a temperature so that the reaction of EA and condensed polyphosphoric acid goes to completion.
